(19) United States
(12) Patent Application Publication
(10) Pub. No.: US 2014/0201935 A1
(43) Pub. Date: Jul. 24, 2014

(54) Collapsible Paint Roller Frame

(71) Applicant: Ryan McGann, Shoreham, NY (US)

(72) Inventor: Ryan McGann, Shoreham, NY (US)

(21) Appl. No.: 13/909,176

(22) Filed: Jun. 4, 2013

Related U.S. Application Data
(60) Provisional application No. 61/655,081, filed on Jun. 4, 2012.

(51) Int. Cl. B05C 17/02

(52) U.S. Cl. CPC B05C 17/0205
USPC 15/144.1

(57) ABSTRACT

A collapsible paint roller frame includes: an axle and means configured to receive a roller cover; a first link; a second link; a coupler configured to fixedly receive the axle and to receive a first end of the first and second links in a pivotal relation; and a handle configured to receive a second end of the first and second links in a pivotal relation. The handle is movable with respect to the axle, using the first and second links, between collapsed and extended positions. The collapsed position permits easy storage of the roller frame in small spaces, and also an efficient arrangement of multiple roller frames in a shipping carton, reducing packaging/shipping costs. A torsion spring engages one link to bias the handle relative to the axle into the collapsed position. A trigger movable between first and second positions releasably secures the handle in the collapsed and/or extended positions.

### CROSS REFERENCES TO RELATED APPLICATIONS

This application claims priority on U.S. Provisional Application Ser. No. 61/655,081 filed on Jun. 4, 2012, the disclosures of which are incorporated herein by reference.

### FIELD OF THE INVENTION

The present invention relates to improvements in paint roller frames, and more particularly to a roller frame that is specially adapted to be easily collapsed for storage and easily extended for use in applying paints and other liquid or semi-liquid substances over a large surface area.

### BACKGROUND OF THE INVENTION

There are many instances today, where either a brush or a roller applicator may serve in applying a liquid or a higher viscosity, semi-liquid substance, to a surface. A roller applicator is very well suited for dispensing the substance onto large surfaces, in a rapid and efficient manner. A conventional “paint roller” has typically consisted of a roller frame that is adapted to receive a cylindrical roller cover/sleeve, where the roller cover is adapted to absorb paint when immersed within a pan, and then evenly disperse the paint from the roller upon the surface to be coated. Thus, the cover is often a cylindrical core with a pile fabric covering. The frame may receive the roller and permit its rotation thereon, while being held at another end using a handle. The size and arrangement of this conventional paint roller is very large and awkwardly shaped for efficient storage within a portable tool box, or even its original shipping carton.

The first paint roller is credited as having been devised by Norman Breakley of Toronto, in 1940. However, the first U.S. patent was by Richard Adams, an engineer for the Sherwin-Williams Company, who constructed and patented the Roller-Koater® as an alternative to brushes, as they were in short supply during World War II because of the restricted availability of hog bristles. Since that time, there have been numerous improvements made to the paint roller. For example, U.S. Pat. No. 3,273,192 to Mazzella was for a “Paint Roller Having a Pivotally Adjustable Handle,” in order to permit its use “in locations where it is desirable to have the handle angularly related to the shank.” Similar functionality was taught by U.S. Pat. No. 5,860,902 to Jang for a “Paint Roller Frame with an Adjustable Handle,” and by U.S. Pat. No. 6,148,469 to Irven for “Adjustable Handle for Edging Paint Roller.” However, despite such improvements to assist in applying the paint, there remains an unmet need for a paint roller frame that is specifically adapted to being collapsible, so as to ameliorate its bulkiness, and render it much more susceptible to compact storage within a portable tool box or storage/shipping container. The present invention is adapted to providing a roller frame capable of being collapsed into a compact envelope.

### OBJECTS OF THE INVENTION

It is an object of the invention to provide a roller frame capable of receiving a roller cover, and capable of being held and manipulated for the purpose of applying liquid or a semi-liquid substances onto a surface.

It is another object of the invention to provide a paint roller frame that is capable of being folded into a collapsed position comprising a compact shape, for easy storage.

It is a further object of the invention to provide a locking means for locking of the collapsible roller frame while in either or both of the folded and unfolded positions.

It is another object of the invention to provide a quick release locking means for easy conversion of the roller frame between the collapsed and extended positions.

It is also an object of the invention to provide a means of biasing the roller frame to be in either of the folded or unfolded positions.

Further objects and advantages of the invention will become apparent from the following description and claims, and from the accompanying drawings.

### SUMMARY OF THE INVENTION

A paint roller frame disclosed herein, for use in receiving a roller cover capable of collecting and dispersing paint or other substances, may comprise unique geometry and a mechanism that may be locked in a first or a second position. The first position may be an extended position that effectively permits the user to grasp a handle of the frame and manipulate it to cause rotation of a roller cover, during application of the substance. The second position is a collapsed or folded position resulting in a compact envelope that is more suitable for easy storage within a tool box, allowing many such folded roller frames to be compactly and neatly stored therein in a stacked relationship.

The collapsible paint roller frame may comprise: a mounting member or coupler, for supporting: an axle to slidably receive a roller cover; a first link having a first end and a second end, with its first end being pivotally coupled to a portion of the mounting member, and its second end being pivotally mounted on the handle; a second link having a first end and a second end, with its first end being pivotally coupled to another portion of the mounting member; and a handle that pivotally receives the second end of the first and second links at discrete positions.

An extension spring or a compression spring (possibly a constant force spring), or a torsion spring may be used to bias one or more of the links. In one embodiment, a torsion spring may be used and may comprise one or more helical windings whose ends may serve to bias the roller frame into either the collapsed or the extended positions, depending upon its installation. In one embodiment, the torsion spring may serve to bias the frame to remain in the extended position, and have a sufficiently high spring constant so as to resist collapse while the user is applying a force to the handle that causes rotation of the roller cover and the paint thereon to be dispersed onto the surface needing to be coated. This would necessitate that the user apply a somewhat greater force in order to intentionally cause collapse of the roller frame, once the user has completed the task, and seeks to store the roller frame. A clip or Velcro strap may thereafter be used to retain the roller frame in the collapsed state.

In another embodiment, the collapsible roller frame may utilize a torsion spring with a smaller spring constant, as the frame may further comprise a locking feature for use in positively securing of the biased link(s) in either the collapsed or extended positions. In one embodiment, the locking feature may comprise a cylindrical lock barrel being received over the windings of the torsion spring, with an end of the first link being received through a keyway in an end wall of the cylindrical lock barrel, to thereby interconnect the biased first link with the lock barrel. Other means of interconnecting the first link with the lock barrel are discussed hereinafter. The second end of the first link may be biased by receiving a radial over-center end of the torsion spring, while a tangential second end of the torsion spring contacts the handle. A slidable/pivotable trigger being mounted to the handle may be movable between a first and a second position, with the first position comprising a position in which a portion of the trigger engages the lock barrel to thereby prevent rotational movement of the lock barrel relative to the handle, and the second position comprising a position where the trigger is disengaged from the lock barrel and permits rotational movement of the lock barrel and links. Locking by the trigger may be accomplished by having a bolt portion thereon that may, when in the engaged trigger position, be slid into one of two orifices in the lock cylinder. The trigger may thus be usable to secure the first link relative to the handle, and thereby inhibit movement of the handle, relative to the roller cover, while at either the collapsed position or the extended positions, using the first and second orifices, respectively.

Collapsing/folding of the paint roller frame of the present invention may result in its handle being proximate to the mounting member and roller cover. In fact, the first and second links may be formed so that the handle may end up parallel to the axle and roller cover, and may even be in contact therewith, when in the collapsed position.

### BRIEF DESCRIPTION OF THE DRAWINGS

FIG. 1 is a side view of a paint roller of the prior art, having an adjustable handle.

FIG. 2 is an enlarged detail view of the prior art paint roller of FIG. 1.

FIG. 3 is a perspective view of the collapsible paint roller frame of the current invention.

FIG. 4 is the collapsible paint roller frame of FIG. 3, being used in conjunction with a roller cover to disperse paint in the painting of a wall, and with an extension pole being shown ready to be received within threaded inserts of the handle of the roller frame.

FIG. 5A is a top view of the collapsible paint roller frame of the current invention.

FIG. 5B is the top view of FIG. 5A, but focusing on the handle, and with the trigger being actuated to occupy a disengaged position, and thereby unlock the roller frame mechanism, and permit collapsing of the frame for its storage.

FIG. 5C is the top view of the collapsible paint roller frame of FIG. 5B, but with the frame collapsed and the trigger re-engaged to lock the frame in the collapsed position.

FIG. 5D is the top view of the collapsible paint roller frame of FIG. 5C, showing the trigger being actuated to occupy a disengaged position, and thereby unlock the collapsed frame, and permit moving of the frame back into the extended position of FIG. 5A.

FIG. 5E is an alternate embodiment of the collapsible paint roller frame of FIG. 5C, being without a trigger and lock bolt, and using a C-clip to releasably secure the frame in the collapsed position.

FIG. 5F is a storage box being used to store one or more collapsible paint roller frames of the current invention, which are compactly stored in the collapsed position.

FIG. 5G is an end view of the storage box of FIG. 5F, showing a plurality of collapsible paint roller frames of the present invention neatly and compactly stacked therein.

FIG. 6 is an exploded perspective view of the parts comprising a first embodiment of the collapsible paint roller frame of the current invention.

FIG. 7 is an exploded side view of the parts comprising the first embodiment of the collapsible paint roller frame of the current invention.

FIG. 8A is the top view of the collapsible paint roller frame of FIG. 5A.

FIG. 8B is a side view of the paint roller frame of FIG. 8, showing the trigger, one-half of the handle, and other parts of the roller frame in a partially exploded view.

FIG. 9A is the top view of the collapsible paint roller frame of FIG. 5A.

FIG. 9B is a cross-sectional view through the handle portion of the paint roller frame of FIG. 9A.

FIG. 10 is the perspective view of the collapsible paint roller frame of FIG. 3, but enlarged to show only the portion of the frame proximate to the handle.

FIG. 10A is a perspective view showing the first handle half after receiving the second end of the first link in a hole therein.

FIG. 11A is the perspective view of FIG. 10, but enlarged and with the trigger and the second half of the split handle removed to expose the lock bolt engaged within an orifice in the lock barrel, locking the roller frame in the extended position.

FIG. 11B is the perspective view of FIG. 11A, but with the lock bolt translated to be disengaged from the lock barrel to unlock the frame, while being in the extended position.

FIG. 11C is the perspective view of FIG. 11B, but with the frame having been pivoted into the collapsed position, and with the lock bolt remaining disengaged from the lock barrel.

FIG. 11D is the perspective view of FIG. 11C, with the frame in the collapsed position, and the lock bolt translated to re-engage the lock barrel.

FIG. 12A is a top view of a second half of the split handle of the collapsible paint roller frame of the current invention.

FIG. 12B is a perspective view of the second handle half of FIG. 12A.

FIG. 12C is a side view of the second handle half of FIG. 12A.

FIG. 12D is a top view of a first half of the split handle of the collapsible paint roller frame of the current invention.

FIG. 12E is a perspective view of the first handle half of FIG. 12D.

FIG. 12F is a side view of the first handle half of FIG. 12D.

FIG. 13 is a side view of the roller cage axle of the collapsible paint roller frame of the present invention.

FIG. 14 is a side view of the first link of the collapsible paint roller frame of the present invention.

FIG. 15 is a side view of the second link of the collapsible paint roller frame of the present invention.

FIG. 16A is a perspective view of the coupler member used for fixedly securing of the roller axle therein and for pivotal securing of the first and second links of the collapsible paint roller frame of the present invention.

FIG. 16B is a reverse perspective view of the coupler member of FIG. 16A.

FIG. 16C is a side view of the coupler member of FIG. 16A.

FIG. 17A is a perspective view of the backing member of the collapsible paint roller frame of the present invention.

FIG. 17B is a reverse perspective view of the backing member of FIG. 17A.

FIG. 17C is a side view of the backing member of FIG. 17A.

FIG. 18 is a perspective view of the coupler member of FIG. 16A after receiving the first end of the first link, with the E-clip mounted thereon to prevent sliding of the link relative to the mounting member, and with the second link also pivotally mounted therein.

FIG. 19 is a side view of the torsion spring usable to bias the handle relative to the first link.

FIG. 20 is an end view of the torsion spring of FIG. 20.

FIG. 21A is a perspective view of the lock barrel of the collapsible paint roller frame of the present invention.

FIG. 21B is an end view of the lock barrel of FIG. 21A.

FIG. 22A is a side view of the trigger of the collapsible paint roller frame of the present invention.

FIG. 22B is a rear view of the trigger of FIG. 22A.

FIG. 23A is a perspective view of the lock bolt of the collapsible paint roller frame of the present invention.

FIG. 23B is a side view of the lock bolt of FIG. 23A.

FIG. 24 is a perspective view of the lock bolt of FIG. 23A positioned within the trigger of FIG. 22A,

FIG. 25A is a perspective view of the first half of the threaded, split insert of the present invention, for receiving a threaded handle extension.

FIG. 25B is a front view of the threaded, insert half of FIG. 25A.

FIG. 25C is a perspective view of the second half of the threaded, split insert of the present invention, for receiving a threaded handle extension.

FIG. 25D is a front view of the threaded insert half of FIG. 25A.

FIG. 26 is the roller cover usable with the collapsible paint roller frame of the present invention.

FIG. 27 is a top view of the collapsible paint roller frame of the current invention, being in the collapsed position, but illustrating an alternate embodiment for the trigger and lock bolt.

FIG. 28 is a side of the collapsible paint roller frame with alternate trigger of FIG. 27.

FIG. 29A is a cross-sectional view through the handle portion and an alternate trigger/lock bolt combination of the collapsible paint roller frame of FIG. 27, with the trigger shown prior to being toggled, so that the lock bolt engages the lock cylinder.

FIG. 29B is the cross-sectional view of FIG. 29A, but shown after the trigger has been toggled, so that the lock bolt is disengaged from the lock cylinder.

FIG. 29C is the side view of FIG. 28, but shown with several parts removed, and with the frame in the extended position.

FIG. 29D is the side view of FIG. 29C, but with the trigger toggled, so that the lock bolt is disengaged from the lock cylinder.

FIG. 30A is the top view of FIG. 27, but shown with the first handle half removed to reveal the lock bolt in an engaged position, and with the frame in the extended position.

FIG. 30B is the top view of FIG. 30A, but shown with the lock bolt in a disengaged position.

FIG. 30C is the top view of FIG. 30B, but shown with the frame in the retracted position, while the lock bolt remains in a disengaged position.

FIG. 30D is the top view of FIG. 30C, but shown with the lock bolt re-engaged to secure the frame in the retracted position.

FIG. 30E is a perspective view of an alternate embodiment of the collapsible paint roller frame of FIG. 3, having a different trigger/lock bolt arrangement, being in the form of an actuating lever and a corresponding mechanism.

FIG. 30F is a front view of the paint roller frame of FIG. 30E, showing one of the handle-halves removed to expose the mechanism, and with the roller shown in the collapsed position and the mechanism locked.

FIG. 30G is the view of FIG. 30F shown as a perspective view.

FIG. 30H is the front view of FIG. 30F, but with the roller shown in the extended position, and being enlarged to show the mechanism in greater detail.

FIG. 30I is the front view of FIG. 30H, but shown with the actuating lever having been actuated to cause the lock bolt to translate out from the lock cylinder, to unlock the mechanism.

FIG. 30J is the front view of FIG. 30J, but shown with the roller in the collapsed position and the mechanism remaining unlocked.

FIG. 30K is the front view of FIG. 30J, but shown with the actuating lever having been released to cause the lock bolt to translate into a second opening in the lock cylinder, to lock the mechanism.

FIG. 31A is an alternate embodiment of the current invention, replacing the trigger and lock bolt combination with a jaw lock mechanism and trigger, with the lock in a closed position, and with the frame shown in the retracted position.

FIG. 31B is the alternate embodiment of FIG. 31A, but with the first jaw lock being in an unlocked position.

FIG. 31C is the alternate embodiment of FIG. 31B, but with the frame pivoted to be in the extended position, and with the second jaw lock shown in the unlocked position.

FIG. 31D is the alternate embodiment of FIG. 31C, but with the second jaw lock shown in the locked position.

FIG. 32 is a perspective view of an alternate embodiment of the current invention, replacing the trigger and lock bolt combination with a clutch-brake lock mechanism.

FIG. 32A is a side view of the clutch-brake lock mechanism of FIG. 32, shown with the clutch engaged.

FIG. 32B is a side view of the clutch-brake lock mechanism of FIG. 32, shown with the clutch disengaged.

FIG. 33 shows an alternate embodiment for the handle that incorporates a metal support channel therein to increase its rigidity.

### DETAILED DESCRIPTION OF THE INVENTION

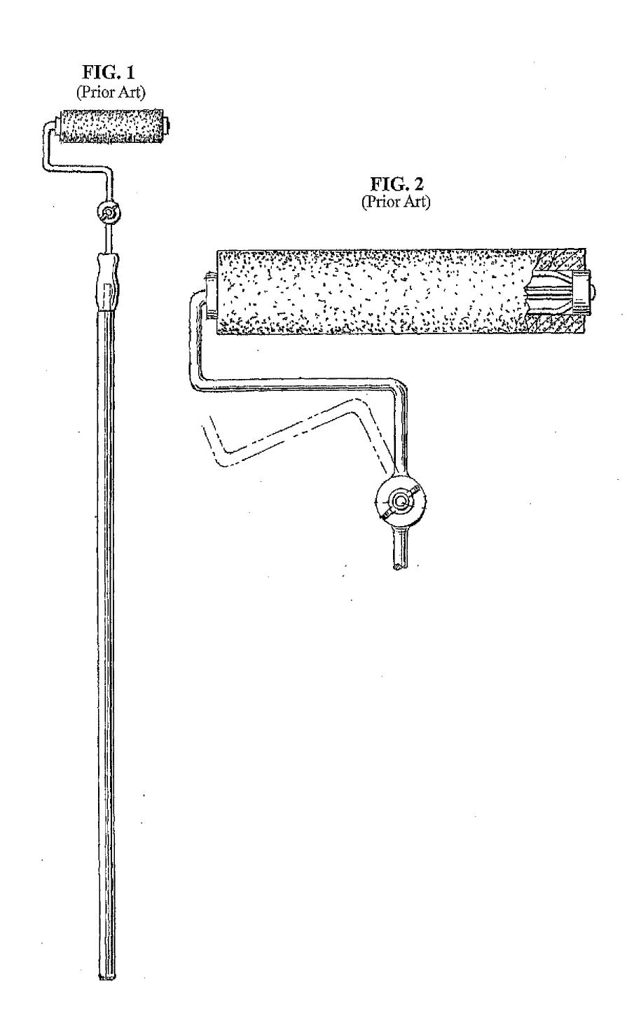

A prior art paint roller frame is shown within FIGS. 1 and 2, which illustrate the corresponding figures of U.S. Pat. No. 3,273,192 to Mazzella. The Mazzella roller frame includes an axle cage comprised of longitudinal rods whose ends are secured in collars that are rotatably received on a central rod or axle, with the roller cage being capable of receiving the roller cover. The rod forming the axle is bent at right angles, and ordinarily, a distal free end of the rod that extends away from the roller cover is equipped with a handle. Mazzella adds an adjustable joint to that arrangement at a central point on the rod portion that extends orthogonally away from the roller cover, to permit adjustment of the handle to be at a desired angular relationship with the roller cover.

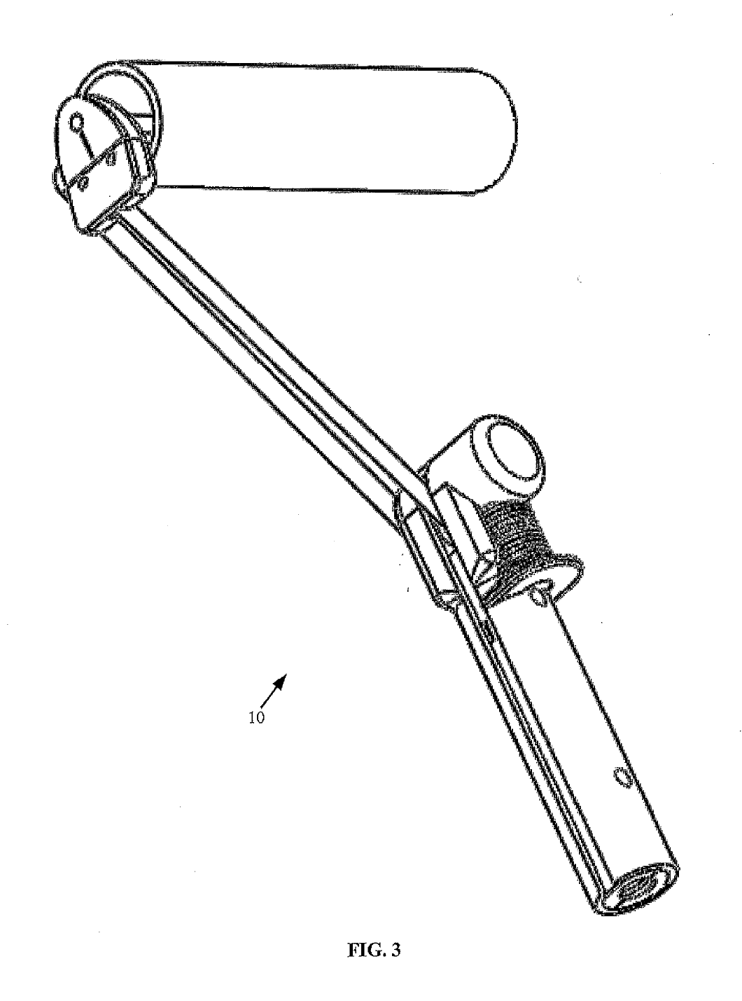

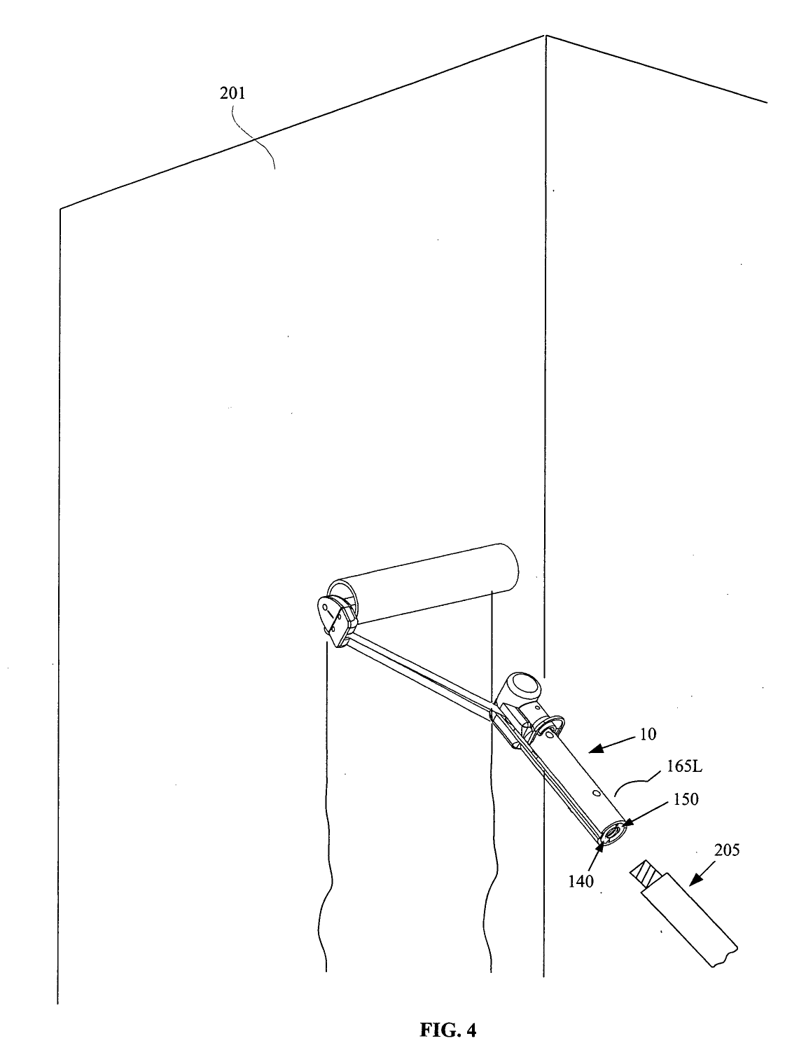

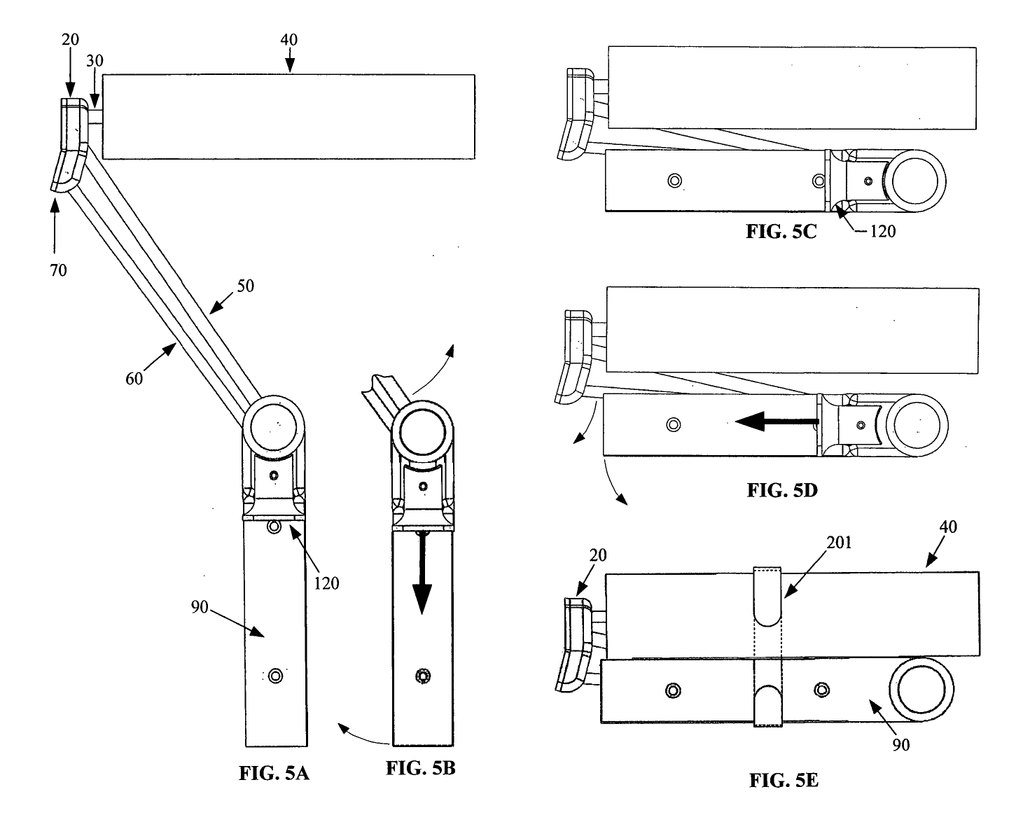

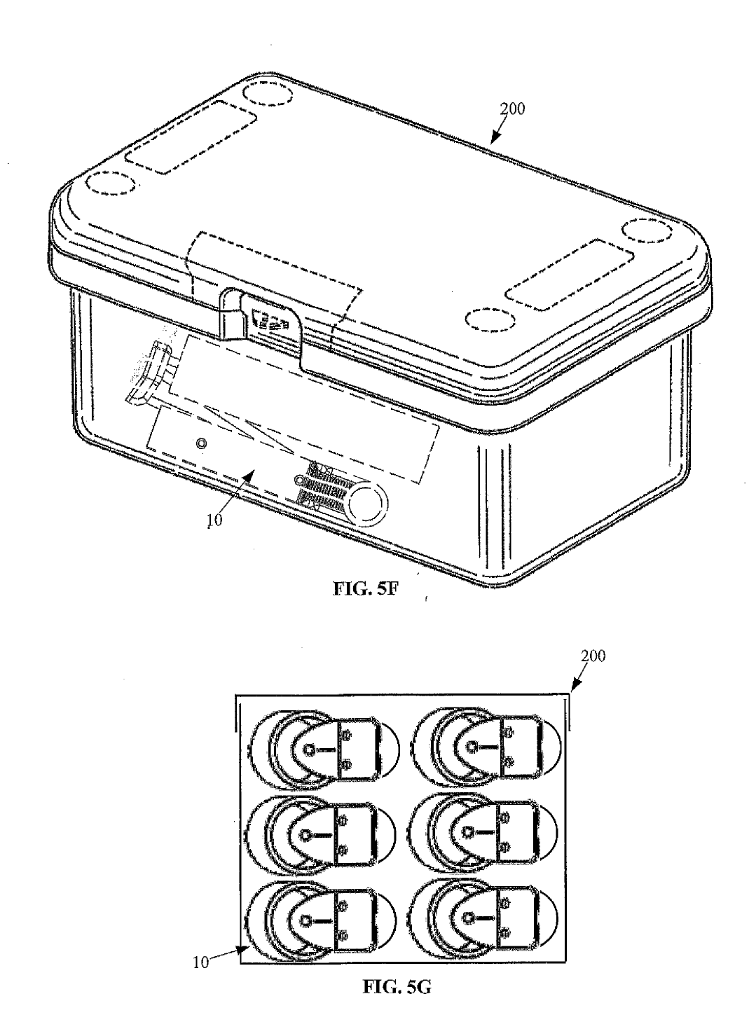

FIG. 3 illustrates a perspective view of the collapsible paint roller frame 10 of the current invention. The collapsible paint roller frame 10 is shown, within FIG. 4, being used to cause rotation of a roller cover upon a wall 201, to thereon disperse paint or other substances. The frame may therefore be used to have the roller cover apply paint to a surface, or to apply a coat of wallpaper sizing to a wall, or to apply adhesive to the back of wallpaper to be hung on the wall, or to apply a seal coating to a blacktop (asphalt) pavement, or to apply a liquid or any other higher viscosity, semi-liquid substance to a particular surface. The advantageous nature of the present roller frame is found within its unique linkage geometry that permits the frame to be transformed from the extended position shown within FIG. 5A, into the collapsed position shown within FIG. 5C (or the collapsed position of an alternative embodiment seen in FIG. 5E). The collapsed position for the roller frame 10 results in a compact and convenient envelope that permits stacking of a plurality of the collapsed roller frames 10 within a storage container or tool box 200, to therein require a minimal volume, as seen within FIGS. 5F and 5G.

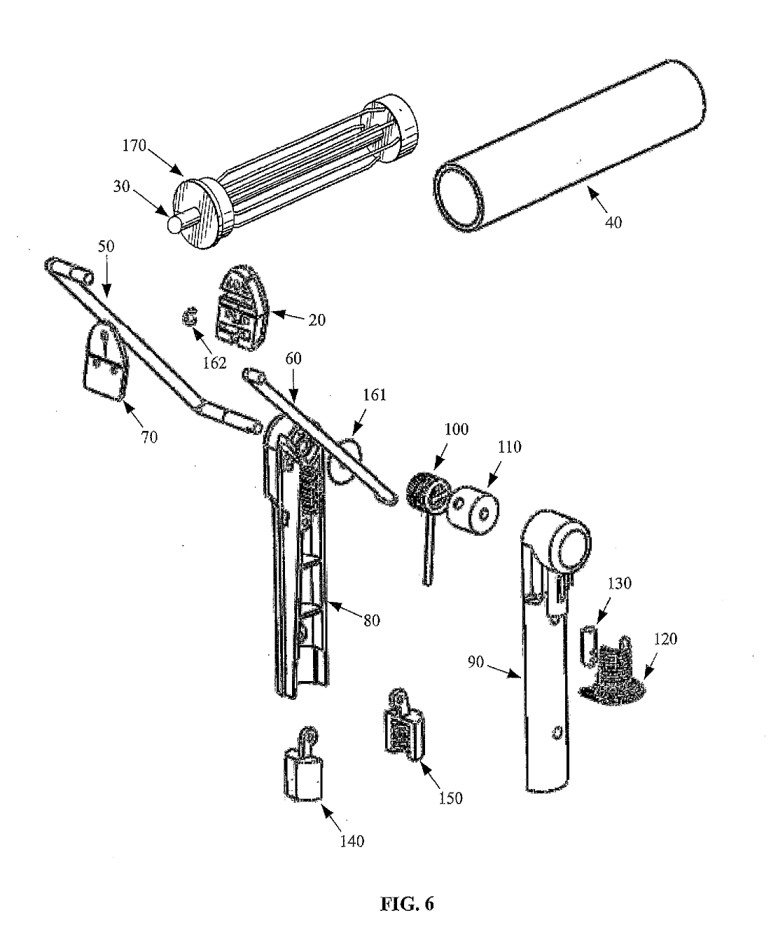

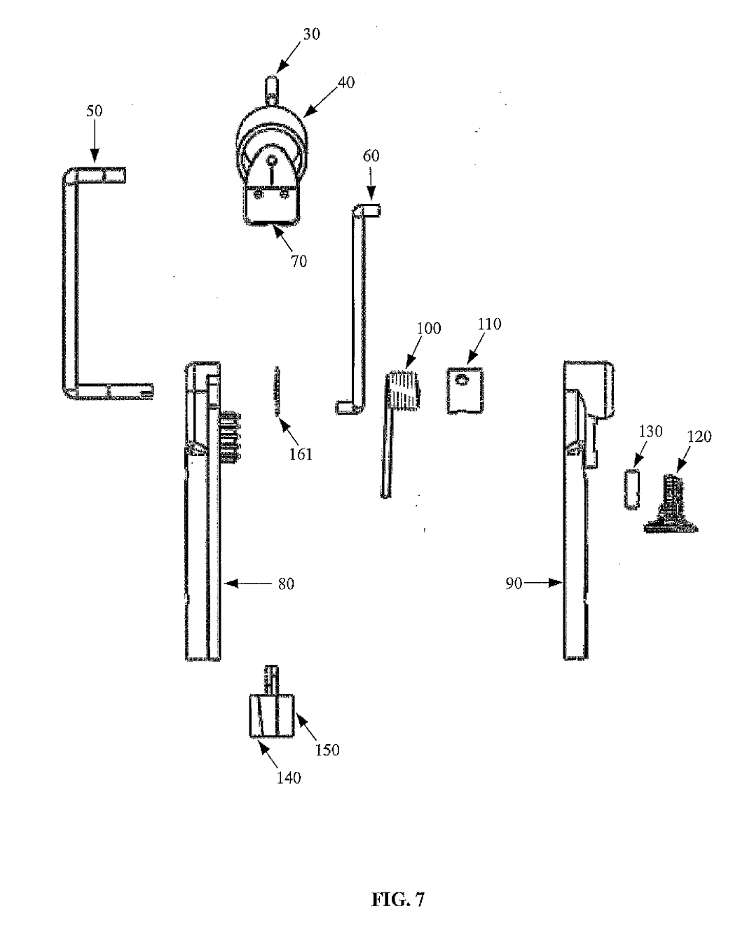

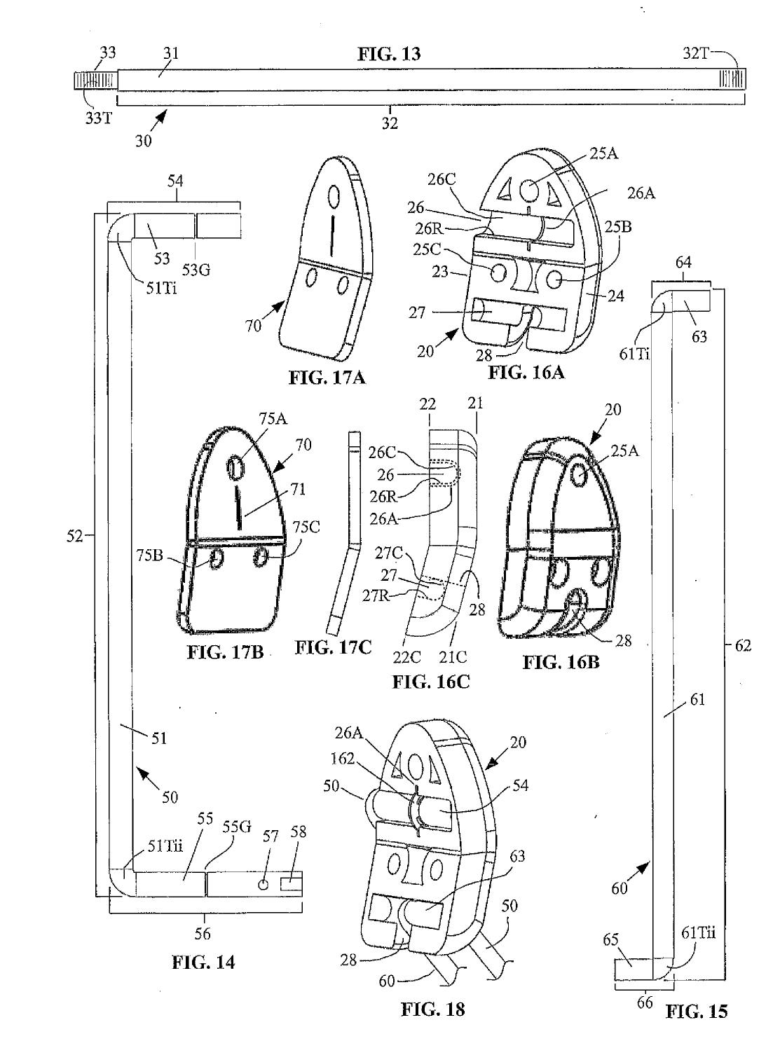

FIG. 6 illustrates a perspective exploded view of the parts comprising the roller frame 10 of FIG. 3. Assembly and operation of the roller frame 10 may initially be understood from a discussion of FIG. 6 and FIGS. 13-18. Axle 30 (FIG. 13) may comprise a cylinder 31 having a length 32. Cylinder 31 may transition into a second cylinder 33 having a slightly smaller diameter than that of cylinder 31. Cylinder 31 of axle 30 may be usable for slidably receiving cage 170 formed of longitudinal rods with end collars, similar to the cage in the patent to Mazzella, which may in turn receive a roller cover 40 (FIG. 26). The cage 170 may be rotatably secured on the axle using a nut that may be torqued onto the threads 32T. The smaller diameter of second cylinder 33 may be received within an orifice in the coupler member 20.

Coupler 20 (FIGS. 16A-16C), as well as the other parts of paint roller frame 10, may be formed of metal, wood, or plastic, and it may be that certain parts of the frame may be metallic while others are optimally made of plastic. Coupler 20 (FIGS. 16A-16C) may comprise a member having features adapted to receive several of the parts of the roller frame 10. The coupler 20 may have a first side 21 and second side 22. A lower portion of the coupler 20 may be canted, and thus, first side 21 and second side 22 may transition into first canted side 21C and second canted side 22C, respectively. First side 21 of coupler 20 may have an orifice 25A therein that is usable for receiving the smaller diameter of second cylinder 33 of axle 30, for mounting of the axle to the coupler. Cylinder 33 may be received therein using a friction fit, or using any suitable adhesive/epoxy, or using mechanical fasteners, including, but not limited to, screws. In addition, cylinder 33 may comprise external threading 33T, which may be used to engage corresponding internal threading within orifice 25A.

The second side 22 of coupler 20 may have a cylindrical recess 26C that may have its axis be oriented orthogonally with respect to the axis of orifice 25A and axle 30. Cylindrical recess 26C may be formed between first side 21 and second side 22, and may begin at one end 23 of the coupler and extend to a certain depth without piercing, the opposite end 24 of the coupler. An overall recess 26 may comprise cylindrical recess 26C and a second, rectangular recess 26R that begins at the second side 22 and connects to the cylindrical recess portion 26C, as seen in FIG. 16C. In addition, a narrow recess 26A, being an annular recess that may transition into a slotted portion, may generally be centered upon recess 26. The second canted side 22C of coupler 20 may also have a similarly formed recess 27, which may comprise a cylindrical recess portion 27C and a rectangular recess portion 27R, except that recess 27 may not begin at one end of the coupler and may instead, as seen in FIG. 16A, stop before piercing either of its ends, 23 and 24. A slotted opening 28 may begin at a bottom of the coupler 20 and pierce all the way from first canted side 21C through the second canted side 22C, and may extend upward sufficiently to transect recess 27.

A first link 50 (FIG. 14) may comprise a wide “U” shape, with a base member of the “U” being a cylinder 51 of sufficient length, so as to have a transition 51Ti into a first leg 53 at one end of the “U,” and a transition 51Tii into a second leg 55 at a distal opposite end of the “U.” Therefore, the first leg 53 and second leg 55 may be parallel to each other, with both legs being orthogonal to the cylindrical base 51, and with both legs 53 and 55 extending in the same direction away from base 51. The overall length 52 of base leg 51 may be set to provide a suitable distance between the handle and roller cover (see FIG. 3). First leg 53 may comprise an annular groove 53G. The second leg 55 may similarly comprise an annular groove 55G, as well as a transverse hole 57, and a flat 58 forming a D-shaped “key” configuration (“D-profile”) at the end of the second leg, which is discussed in further detail hereinafter.

A second link 60 (FIG. 15) may comprise a tall upright “Z” shape, having a cylindrical upright (base) leg 61 of sufficient length, so as to have a transition 61Ti into a first leg 63 at one end, and a transition 61Tii into a second leg 65 at a distal opposite end. Therefore, the first leg 63 and second leg 65 may be parallel to each other, with both legs being orthogonal to upright leg 61, but with both legs 63 and 65 extending in opposite directions away from upright leg 61.

The first leg 53 of first link 50 may be pivotally received within recess 26 of the coupler 20 (FIG. 18), with an E-clip 162 secured upon groove 53G of the first leg being received within the annular recess 26A. Therefore, the position of the annular groove 54G relative to the transition 51Ti on link 50 may correspond to (be slightly greater than) the distance that the annular recess 26A is positioned along the axial length of the recess 26 from the end 23 of the coupler that it pierces, in order for the first link 50 to pivot relative to the coupler 20. (Note—rather than using a separate part in the form of an E-clip to retain the first leg 53 of the first link 50 from sliding out of the recess 26 of coupler 20, an annular lip being integral to the leg may instead be used, or the first leg 50 may instead have an additional bend with a small extension therefrom that may be used to retain the link in the recess).

The first leg 63 of second link 60 may be pivotally received within recess 27 of the coupler 20, so that the portion of the upright leg 61 being proximate to the first leg may be aligned to freely pivot through the slotted opening 28. Note that other geometric shapes may also be used for the first and second links. For example, the second link may alternatively comprise a “U” shape, with its first leg being pivotally received in the recess 27 on the other side of slotted opening 28. As another example, both the first link 50 and the second link 60 could be just a straight rod or a bar with holes in its ends, and with one end of the rod/bar being pivotally secured to the coupler 20 using a simple pinned connection, and the other end having a pinned connection as well, which would better facilitate the single piece housing discussed hereinafter.

Small protrusions may be used on second side 22 and on second canted side 22C of coupler 20 to laterally retain the first link 50 and second link 60 in the respective recesses 26 and 27 (FIG. 16C), so that the links may only need to initially be snapped into the recesses, but would thereafter be capable of pivotal movement without being able to slip out therefrom. Alternatively, the first leg 53 and the first leg 63 of the first and second links, respectively, may have a slight machine taper—e.g., a Morse taper—to form a conical shape that is pivotable and also useable for retention of the first leg within the recess, which may have the corresponding conical shape.

Also, a back support member 70 (FIG. 17-17C) may be used in addition to or in lieu of the protrusions or the Morse taper, to maintain the first link 50 and second link 60 in the respective recesses 26 and 27, or to just simply cover the recesses in the coupler 20. Holes 75A, 75B, and 75C in the back support member 70 may permit securing of the member to the corresponding holes 25A, 25B, and 25C of coupler 20 using mechanical fasteners, including, but not limited to, screws. A screw being secured through hole 75A of support member 70 and through hole 25A of coupler 20 may also be simultaneously used to secure the axle 30 to the coupler. Alternatively, a nut may be nested within back support member 70 to receive the external threading 33T of cylinder 33 of axle 30, which may be used to secure both the axle 30 and the back support member 70. The end of cylinder 31 of axle 30 being opposite to the end that transitions to cylinder 33 may have a recess therein to be able to receive a hex-shaped “Allen” key for torquing of the axle, or for being able to restrain the axle from rotational movement in order to torque the aforementioned nut. The back support member 70 may also have a slot 71 that is positioned to be able to receive the E-clip 162 that is secured upon groove 53G of first link 50, which may be protruding out past the second canted side 22 of the coupler 20.

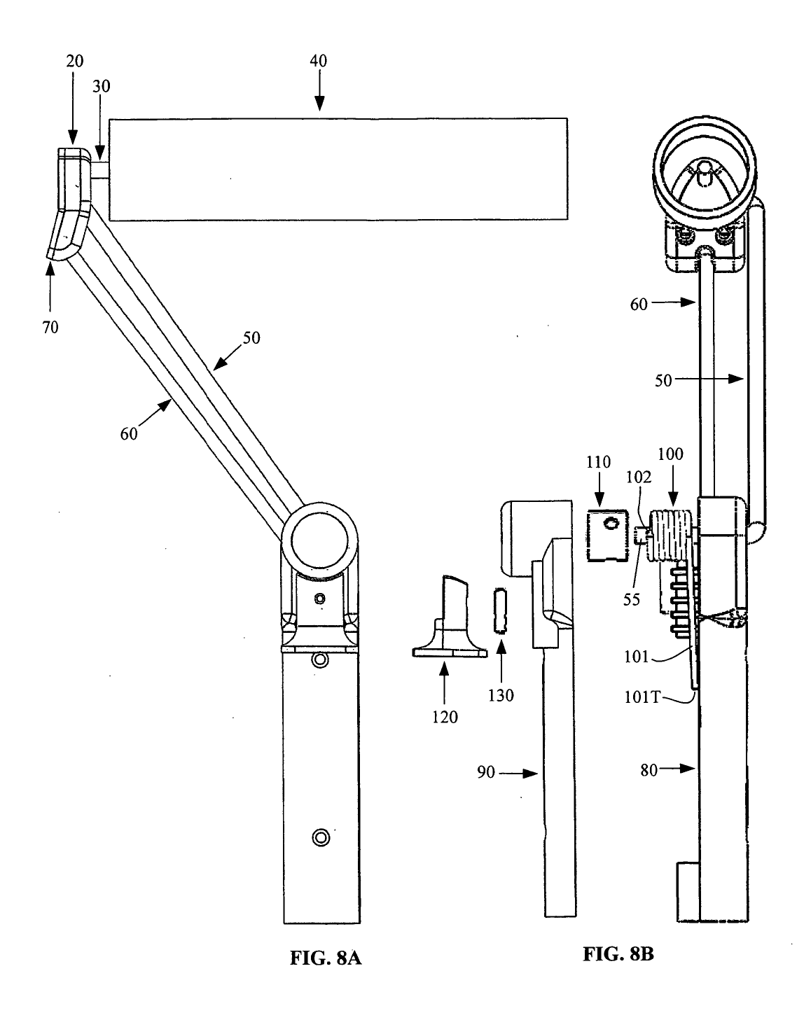

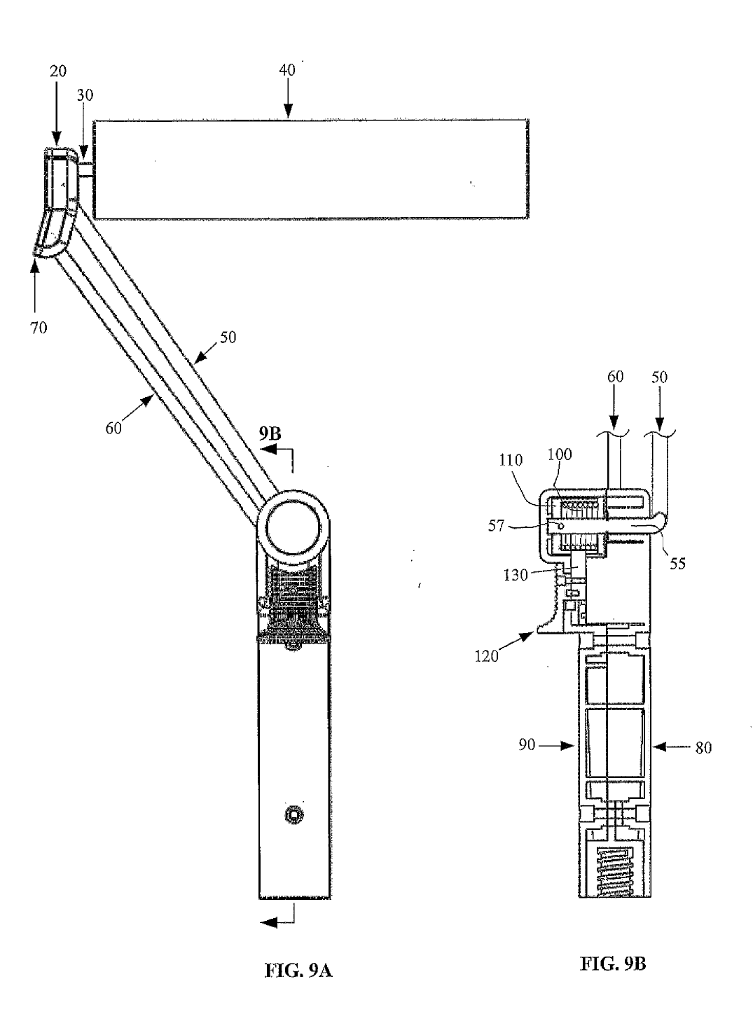

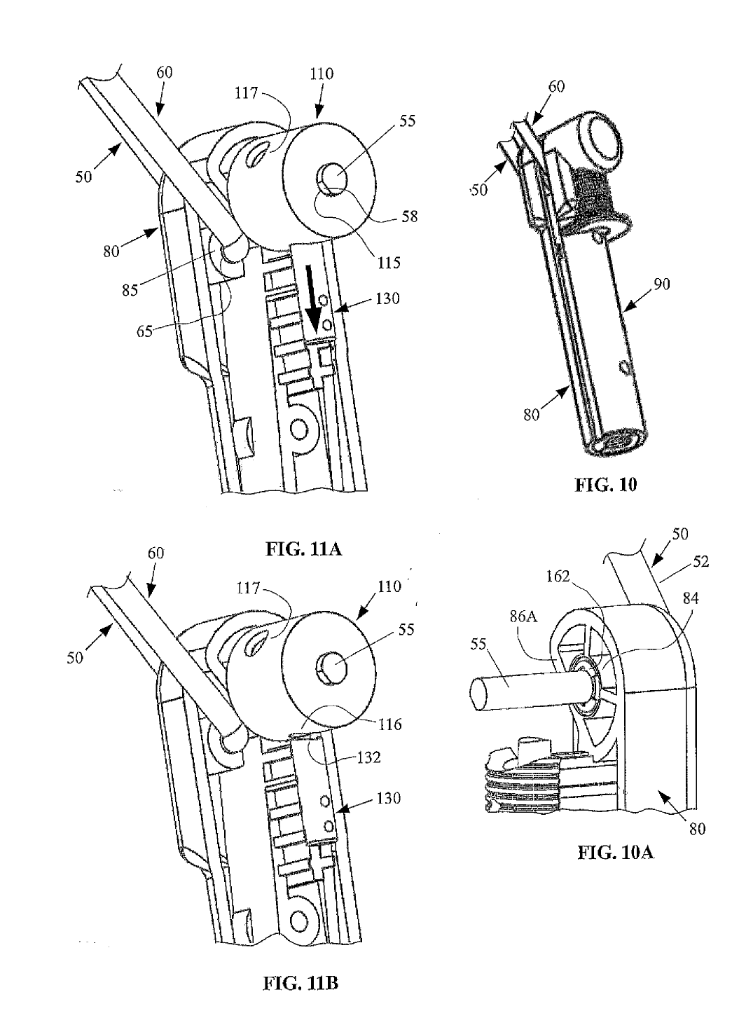

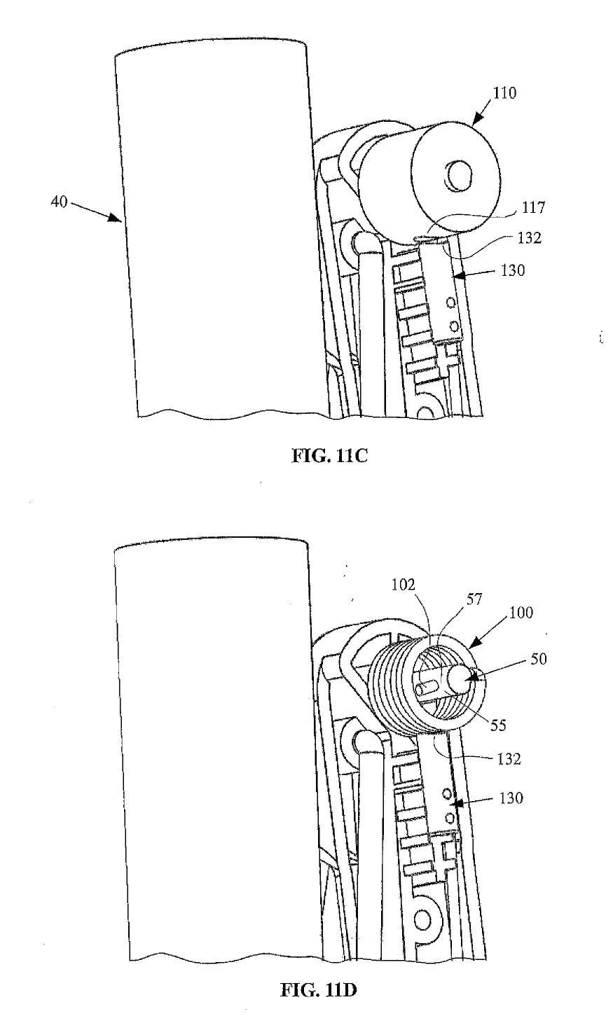

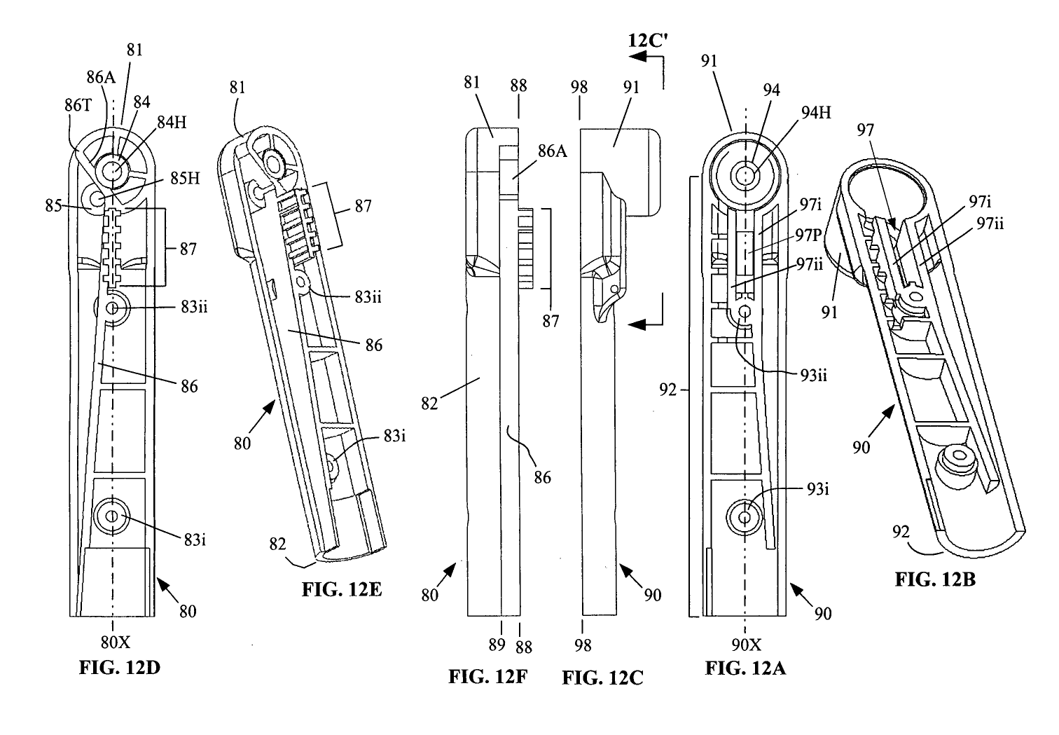

The opposite ends of the first link 50 and second link 60 (second leg 55 and second leg 65) may be pivotally secured within the handle. The assembly of the lower portion of the collapsible paint roller frame 10 may be seen within the partially exploded view of FIG. 8B and the assembled view of FIG. 9B. However, the pivotal attachment of the second leg 55 and second leg 65 of first and second links 50 and 60 at discrete positions in the handle may be understood from viewing FIGS. 10A and 11A, as well as by viewing details of the handle, as seen in FIGS. 12A-12C.

The handle may comprise a single part, however, for ease of assembly and manufacture, the handle may be split into a first handle half 80 and a second handle half 90. Handle half 80 may generally be hollow and be formed to have an outer wall and exterior surface, having a hub portion 81, from which may extend a curved, graspable handle portion 82. Protruding from the outer wall into the hollow interior of the handle half 80 may be several features to permit assembly of the component parts of the roller frame 10. Protruding into the interior of the handle portion 82 may be a first boss 83i and a second boss 83ii, with each having a thru-hole therein, which may be usable for securing the first handle half 80 to the second handle half 90, using mechanical fasteners, including, but not limited to, screws, or nuts and bolts. Various internal stiffeners may also be positioned within the interior of handle half 80 to provide rigidity and support as needed. In the interior of the hub portion 81, may be a cylindrical boss 84, having a hole 84H therein. Positioned in proximity to cylindrical boss 84, and being offset from the axis 80X of handle portion 82, may be another cylindrical boss 85, which may have a hole 85H therein. A stiffener 86 may also protrude into the handle half 80 and run generally from the boss 84 to the end of the handle portion 82, and may also be oriented at an angle to the axis 80X. Upon approaching boss 84, stiffener 86 may angle into stiffener portion 86A, which may be oriented to run between boss 84 and boss 85, and which may have a curved transition 86T into the outer wall at the hub portion 81. An elongated protrusion 87 may also protrude from the outer wall into the hollow interior of the handle half 80, and may preferably protrude beyond the mating plane 88 of handle half 80, as seen in FIG. 12F. The elongated protrusion 87 may run along axis 80X between cylindrical boss 84 and second boss 83ii, and may, in order to save weight, comprise a lattice of individual stiffeners that combine to form a generally rectangular protrusion. As seen in FIG. 12F, the outer wall of the handle half 80 on one side of the handle portion 82 (the side with boss 85) may not extend up to the mating plane 88, and may instead stop at plane 89, thereby exposing a side of the stiffener 86.

The second handle half 90 may also be generally hollow and be formed to have an outer wall and exterior surface, with a hub portion 91, from which may extend a curved, graspable handle portion 92. Protruding from the outer wall into the hollow interior of the handle half 90 may be several features to permit assembly of the component parts of the roller frame 10, and mating of handle half 90 with handle half 80. Protruding into the interior at the handle portion 92 may be a first boss 93i and a second boss 93ii, with each having a thru-hole therein, which may be usable for securing the second handle half 90 to the first and second bosses 83i and 83ii of handle half 80. Various internal stiffeners may also be positioned within the interior of handle half 90 to provide rigidity and support as needed. In the interior of the hub portion 91, may be a shallow depth cylindrical boss 94, having a hole 94H therein. An elongated, generally rectangular recess 97, for receiving protrusion 87 of handle half 80, may be formed in handle half 90 by a first stiffener 97i and a second stiffener 97ii, both of which may run between boss 94 and boss 93ii. First stiffener 97i and second stiffener 97ii may both protrude up to the mating plane 98 (FIG. 12C).

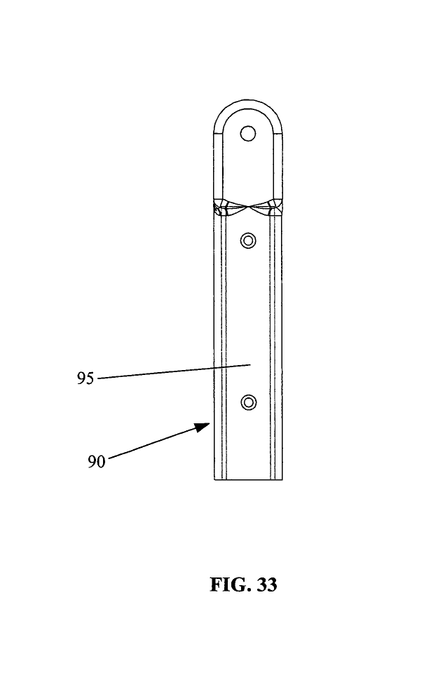

As seen in FIG. 33, a metal support channel 95 may be added to the handle to provide for increased rigidity. The metal support channel 95 may be secured to the handle half 90 in proximity to the trigger using mechanical fasteners, including, but not limited to, screws.

The second leg 55 of the first link 50 and the second leg 65 of second link 60 may each be pivotally mounted within the first handle half 80. As seen within FIG. 10A, the second leg 55 of the U-shaped first link 50 may be caused to approach the exterior surface of handle half 80 and be inserted through the hole 84H in boss 84, until the annular groove 55G is exposed beyond the meeting plane 80X. With the annular groove 55G therefore being exposed beyond the extent of boss 84, an E-clip 162 may be inserted into the annular groove to restrain the second leg 55 of the first link 50 from backing out of the hole 84H, while the second leg nonetheless remains free to pivot therein. The use of the E-clip 162 and the annular groove 54G are optional, because the first leg 53 of first link 50 may be positively retained within recess 26 of the coupler 20 through the subsequent assembly of other component parts of the paint roller frame 10, as discussed hereinafter. However, the use of the E-clip and the annular groove 54G may conveniently serve to facilitate easier assembly of the roller frame.

As seen within FIG. 11A, the second leg 65 of the Z-shaped second link 60, may be inserted into the hole 85H of boss 85, being inserted in the opposite direction as the second leg 55 of the U-shaped first link 50 had been inserted into the hole 84H in boss 84. No E-clip or other retention means is necessary for retaining the second leg 65 of the Z-shaped second link 60 in the hole 85H, because it may be retained therein using the second handle half 90, as seen in FIG. 10, whereby the upright portion 61 of the second link 60 is trapped between the outer wall of the handle half 80 stopping at plane 89, and the outer wall of handle half 90 stopping at plane 98. (Note that the travel of the second leg 65 of the Z-shaped second link 60 may also be limited by the wall 86 of handle half 80). Having the two links, first link 50 and second link 60, being pivotally attached to the coupler 20 that supports the roller cover, and also being pivotally attached to those discrete positions within the handle halve 80, renders the roller cover/coupler combination movable with respect to the handle, so as to be freely moveable between the extended position in FIG. 5A and the collapsed positions of FIGS. 5C and 5E. In order to secure the roller cover/coupler combination relative to the handle at the extended position, for use in applying a substance to a surface, one of several different approaches may be utilized.

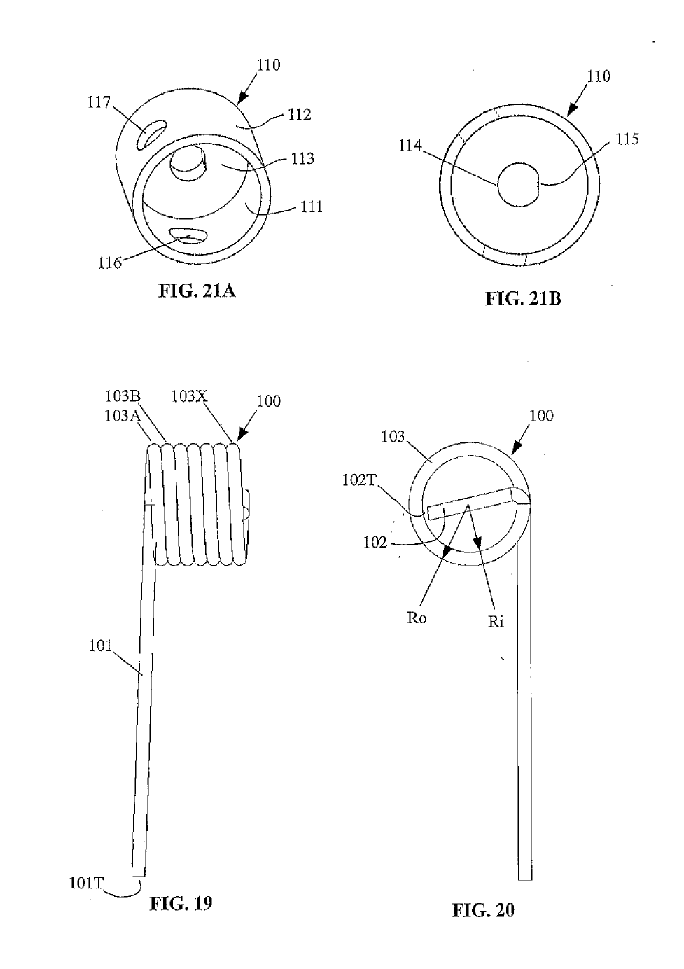

One approach may be to utilize a biasing spring, prior to assembly of the second handle half 90. The spring may be installed to bias one of the links relative to the coupler 20, or to bias one of the links relative to the handle half 80/90, to thereby bias the mechanical arrangement into the extended position. The spring may be a helical tension spring or compression spring that is aptly positioned, and has one end secured to the chosen link, with the other end of the spring secured to the coupler or to the handle. With the use of the first and second legs of the first and second links 50/60 to provide pivotal attachments, biasing by a torsion spring is very efficiently constructed. To be exemplary, an embodiment using a torsion spring is illustrated throughout the figures. Detail views of one possible embodiment of a torsion spring are illustrated in FIGS. 19 and 20.

Torsion spring 100 may comprise wire or rod formed into a series of helical windings 103A, 103B, . . . , 103X that may begin (or terminate) with a first end 101 extending tangentially and having a tip 101T. The series of helical windings of torsion spring 100 may have a second end 102 that may comprise a radial over-center leg, having a tip 102T that terminates before extending beyond the inner radius Ri of the coils 103, as seen in FIG. 20. The helical windings 103 of torsion spring 100 may be received over the second leg 55 of the U-shaped first link 50 that is exposed beyond the meeting plane 80X of handle half 80, as seen in the partially exploded view of FIG. 8B, with the tip 101T of first end 101 being restrained by either the first handle half 80, or by the second handle half 90, before/after they are joined. The tip 102T of the radial over-center second end 102 of torsion spring 100 may be received through orifice 57 of the second leg 55 of the U-shaped first link 50 (FIGS. 9B and 11D) to thereby cause biasing of the of the roller frame 10 into either the collapsed or the extended positions, depending upon the radial positioning of the orifice and the relative positioning of the ends 101 and 102 of the torsion spring 100, which may create preloading to cause clockwise biasing or alternatively create preloading to cause counterclockwise biasing. (Note—as an alternative to interconnecting the spring 100 with the first link 50 by receiving the second end 102 of the spring through the orifice in the leg 55, the two members may be suitably joined using mechanical fasteners, including, but not limited to using a screw, or they may be joined through the use of a welding process.

In this embodiment, the positioning and preloading may be set so that the torsion spring 100 may serve to bias the frame to remain in the extended position. With this arrangement, a torsion spring 100 may preferably be used that has a sufficiently high spring constant, so as to bias the roller frame 10 into the extended position, and thereat resist collapse while the user is applying a force to the handle that causes rotation of the roller cover, with the substance thereon being dispersed onto the surface needing to be coated (FIG. 4). This would necessitate that the user apply a somewhat larger force in order to deliberately cause collapse of the roller frame, once the user has completed the task and seeks to store the roller frame 10 in box 200. After deliberately causing collapse of the roller frame 10 to appear as in FIG. 5E, a strap with Velcro thereon, or an elongated C-shaped clip 201 may be used to retain the roller frame in the collapsed state. A suitable force for collapse may be selected, based on the age/strength of the expected user(s). The corresponding spring constant (K) may be determined using the actual geometry of the frame 10 and the torsion spring relation K=(P)(M)/θ, where P is the load, M is the moment arm, and θ is the angle of deflection from the rest position.

Another approach may be used, in order to secure the roller cover/coupler combination at the extended or collapsed positions relative to the handle, and includes use of a trigger release. A trigger release may be slidably attached to the handle half 90, and be slidable so as to have a portion that is disposed within the handle half 90, within recess 97, so as to engage another orifice in the second leg 55 of the U-shaped first link 50, to thereby inhibit motion of the first link relative to the handle, and therefore inhibit unintentional extension or collapse of the roller frame 10. While it may be advantageous to make the graspable portion of the trigger release from a plastic material, and while the engagement of the portion of the trigger release within the orifice of the first link 50 may more preferably be made from a metallic material, the trigger release may, but need not be, constructed using two parts rather than a single integral part. In addition, because the diameter of the second leg 55 of the U-shaped first link 50 may preferably be relatively small, which may not ideally accommodate a sufficiently sized trigger portion for engagement in the hole of the link leg, based on the loads experienced by such engagement, a separate, larger diameter lock barrel overlaying the torsion spring 100 may instead be engaged to inhibit pivotal motion.

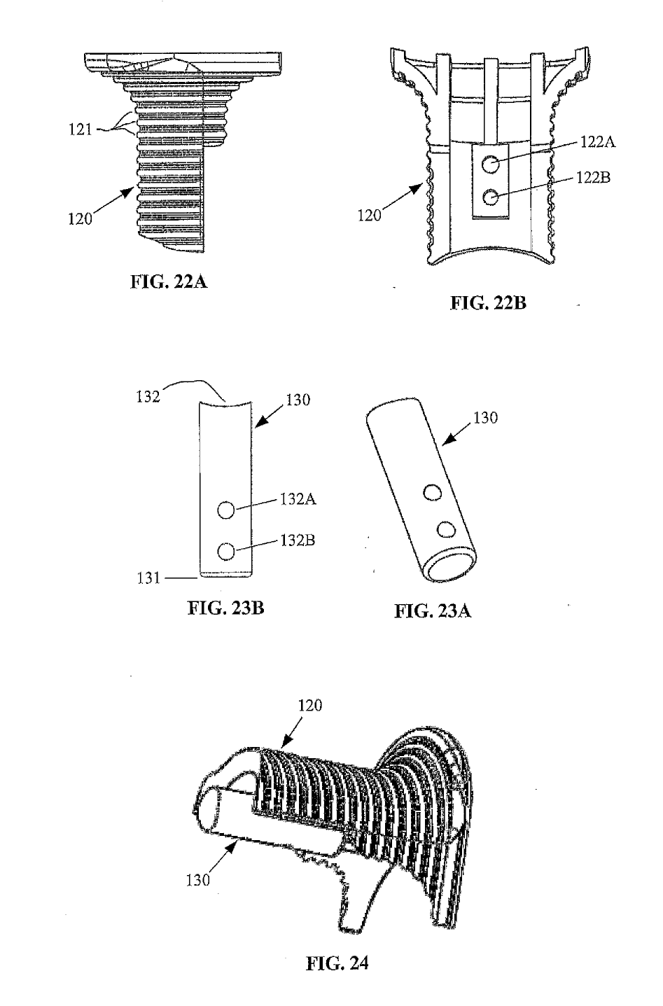

FIGS. 22A and 22B illustrate a separate trigger 120, while FIGS. 23A and 23B illustrate a separate lock bolt 130 that may be mated with the trigger 120. The trigger 120, which may have an undulating exterior surface 121 to aid in being gripped by a user for sliding of the trigger, may have a pair of posts 122A and 122B on the interior surface. The lock bolt 130 may be generally cylindrical, having a first end 131, and a second end 132, which may be curved. The lock bolt 130 may also have a pair of orifices 132A and 13213 that may respectively receive the pair of posts 122A and 122B that are on the interior surface of the trigger 120, and may be retained therein by using a friction fit, or by using adhesive/epoxy, or by having the ends of metallic posts protrude out from the lock bolt orifices and be upset in the same manner as a bucked rivet. Alternatively, the lock bolt may have posts protruding therefrom, which may be received by corresponding orifices in a portion of the trigger.

The protrusion 87 of handle half 80 may only protrude slightly beyond the mating plane 88 so that the rectangular recess 97 of handle half 90 may also therein receive the lock bolt 130 in a slidable relation, with its posts protruding out an opening 97P in the outer wall (FIG. 12A). The posts of lock bolt 130 may then be joined to the trigger 120. A helical compression spring may also be positioned within the recess 97 to bias the lock bolt 130 towards the hub portion 91.

To accommodate installation of the lock bolt 130 and the helical biasing spring, as well as the lock bolt's subsequent joining to the trigger 120, stiffener 97i and second stiffener 97ii may be adapted to protrude inward from the outer wall to a plane being offset from, and slightly less than that of mating plane 98, so that a small, flat, rectangular plate can be fastened to the second handle half 90 using the stiffeners 97i and 97ii, to thereby retain the lock bolt 130 and spring therein. A series of small threaded pins may be used to fasten the flat plate within handle half 90, after the lock bolt 130 and spring have been inserted. This may also permit the connection between the posts of the lock bolt 130 and the orifices of the trigger 120 to be a clearance fit, as the trigger may be slidably received upon a track on the outside of the handle half (FIG. 6), and its sliding motion could be transmitted to the nested and slidable lock bolt, without having a firm connection therebetween.

The lock barrel 110 is illustrated in FIGS. 21A and 21B, and may comprise a hollow cylinder having an interior surface 111, and exterior surface 112, and an end wall 113 at one end of the cylinder. The end wall 113 may have a central opening comprising a D-shaped keyway formed by a part-circular opening 114 that terminates upon a flat portion 115. The open end of the lock barrel 110 may be received over the series of helical windings 103 of torsion spring 100, as seen in FIGS. 8B and 9B, with the lock barrel's D-shaped “keyway” formed by circular opening 114 and flat portion 115 receiving the D-shaped “key” formed by the flat 58 on the end of the cylindrical second leg 55 of first link 50 (FIG. 11A). In place of the “D” shape, other corresponding cross-sectional shapes could be used for the “key,” including, but not limited to a rectangular cross-section. Moreover, in place of using the “key” and “keyway” on the end of the first link and on the end wall of the lock barrel, those parts may be joined together using mechanical fasteners, including, but not limited to, a screw, and they may alternatively be joined through the use of a welding process.

The holes 116 and 117 in lock barrel 110 may be clocked radially about the cylinder, so that upon advancement of the trigger 120, in FIG. 9B, the curved second end 132 of lock bolt 130 may engage one of the holes, when the collapsible paint roller frame 10 is in the extended position, and engage the other hole when the collapsible paint roller frame 10 is in the collapsed position. Note that rather than using a lock “barrel,” a flat washer having first and second notches therein may alternatively be engaged by the lock bolt, with the washer fitting over the “key” in the end of the cylindrical second leg 55 of first link 50, after the torsion spring 100 has been secured therein, and with it being retained upon (keyed with) the link by the joining of the two housing halves 80 and 90.

FIG. 11A shows the lock bolt 130 being in the engaged position, and with the collapsible paint roller frame 10 being at the extended position, while FIG. 1113 shows the lock bolt having been translated by its connection to the trigger (not shown in the view), to be disengaged from orifice 116 of lock bolt 110. FIG. 11C shows the paint roller frame having thereafter been folded to occupy the collapsed position, while FIG. 11D shows the lock bolt having been advanced to engage the lock barrel, which is removed from the figure to show that the curvature at the second end 132 of the lock bolt 130 is formed to provide clearance with the curved outer radius Ro of the windings of the torsion spring 100.

By using the trigger 120 to secure the collapsible roller frame 10 in either or both of the extended and collapsed positions, a torsion spring with a smaller spring constant may be utilized, as it may be locked while being used to apply paint by the user. With this arrangement, the torsion spring may more preferably be set up to bias the collapsible roller frame 10 to be in the collapsed position. Alternatively, the torsion spring can be completely eliminated as the frame can be manually moved by the user between the two positions without any biasing.

Collapsing of the paint roller frame 10 of the present invention may result in its handle being proximate to the roller cover 40. In fact, the first and second links may be formed and pivotally retained so that the handle may end up parallel to the axle 30 and roller cover 40, and may even be in contact therewith, when in the collapsed position (FIG. 5E). However, for an embodiment that uses the trigger and lock bolt, biasing by the torsion spring may also thereby put a load on the lock bolt, as a result of its engagement with the hole in the lock barrel, which may make it somewhat more difficult to actuate the trigger. To reduce this pre-load on the trigger before actuating it, the user may use one hand to grasp the roller cover seen in FIG. 5D, and with the other hand the user may apply a small compressive force to slightly close the gap seen between the handle and the roller cover. This would relieve the pre-load on the trigger, and may also serve to cause the user to more carefully deploy the paint roller frame, rather than simply having it spring open rapidly into the extended position.

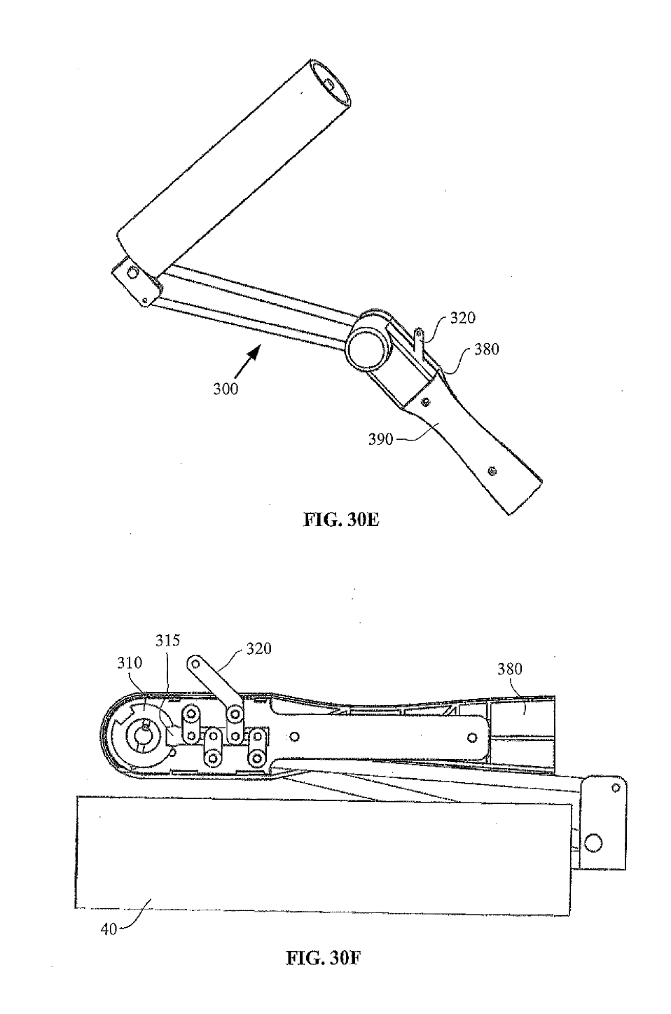

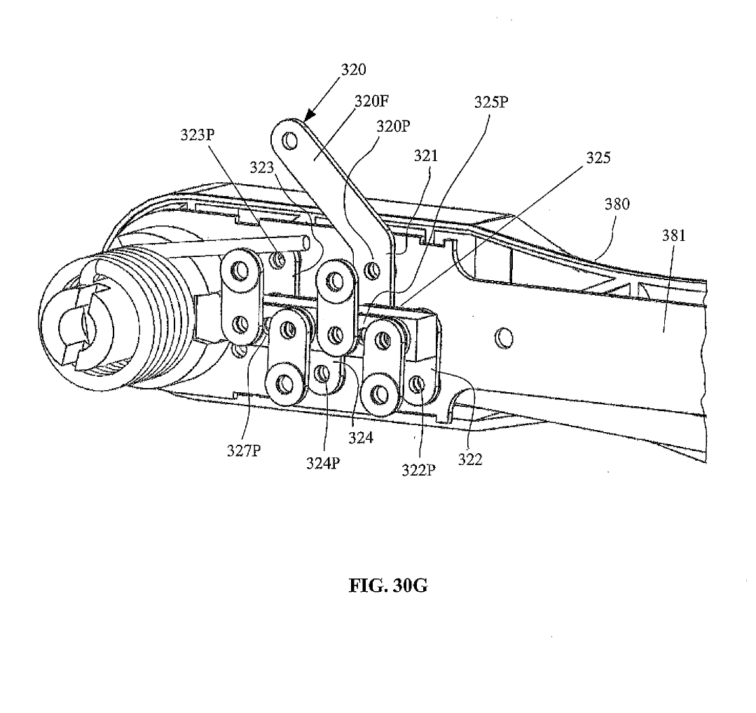

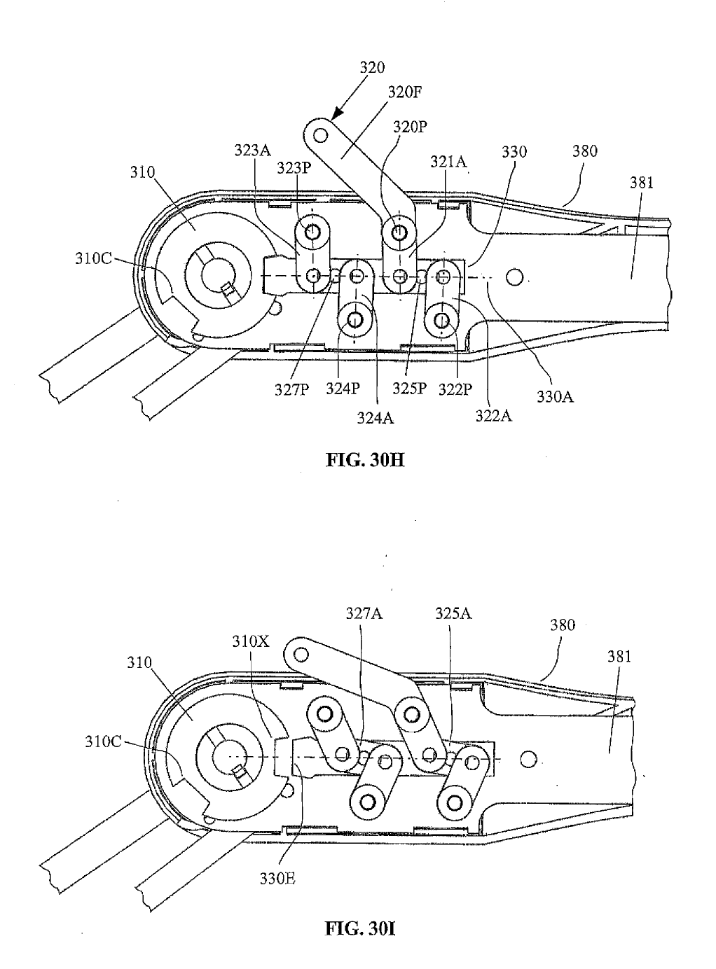

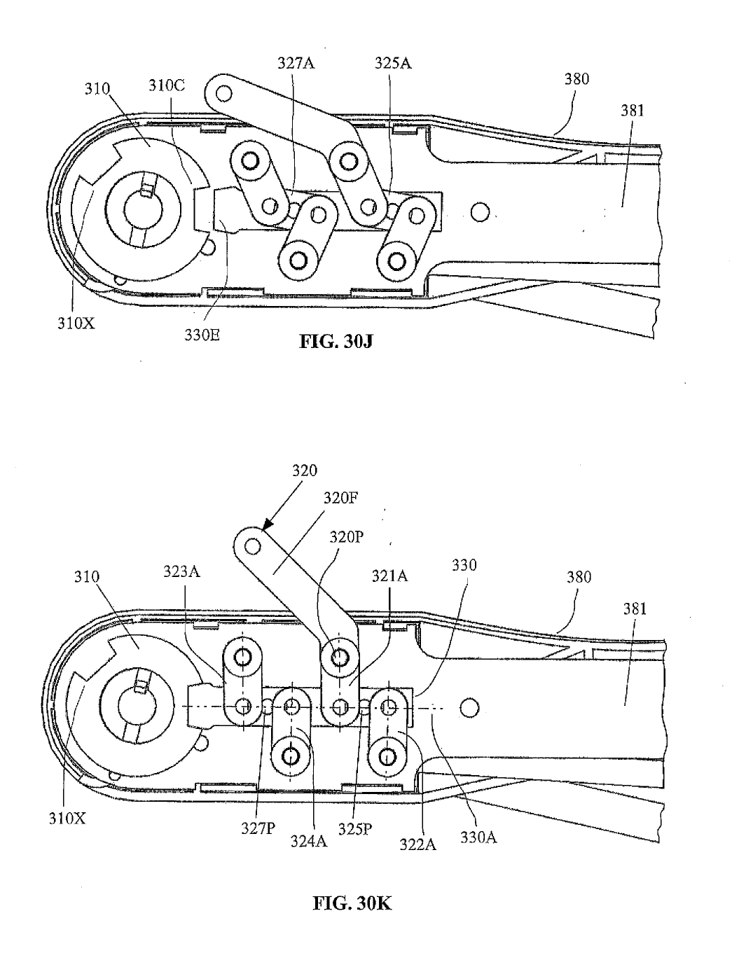

An alternate embodiment of the collapsible paint roller frame of FIG. 3, with its trigger 120 and lock bolt 130 arrangement for locking of the lock barrel 110, is shown within FIGS. 30E-30K. FIG. 30E shows a perspective view of the alternate embodiment-collapsible paint roller frame 300, which may include an actuating lever 320 extending out from between the handle half 380 and handle half 390, and which may be used for actuating the mechanism therein. The paint roller frame 300 is shown in FIG. 30F with the roller and the first and second links in the collapsed position, and with handle half 390 having been removed to expose the mechanism therein that is used for actuating the lock bolt 315. The mechanism is also seen in the enlarged perspective view of FIG. 30G, and within the series of views in FIGS. 30H, 30I, 30J, and 30K, which show the various mechanism positions for locking and unlocking of the lock barrel, to permit positioning of the roller at either the collapsed or the extended positions.

The actuating link or lever 320 of the mechanism may operate analogously to the trigger in paint roller frame 10 for causing locking and unlocking of the lock cylinder, and may include a first arm portion 320F that may transition into a second arm portion 321. The actuating lever 320 may be pivotally secured, at point 320P on second arm portion 321, to the handle half 380, or may instead be pivotally secured to a plate member 381 that is fixedly secured to the handle half 380. A distal end of second arm portion 321 may be pivotally connected to an end of a cross-link member 325. A second link 322 may have a first end that may also be pivotally connected to the plate member 381, but on the opposite side of handle half 380, and the second end of link 322 may be pivotally connected to the opposite end of cross-link member 325. A portion of cross-link member 325, at a mid-point between the pivotal connections of second arm portion 321 and second link 322, may itself have a pivotal connection 325P with a portion of lock bolt 330.

A third link 323 may have a first end that may have a pivotal connection 323P with the plate member 381, on the same side of the handle half 380 as the arm portion 321, and the second end of the third link may be pivotally connected to an end of a cross-link member 327. A fourth link 324 may have a first end that may have a pivotal connection 324P with the plate member 381, but on the same side of handle half 380 as the similar pivotal connection for link 322, and the second end of link 324 may be pivotally connected to the opposite end of cross-link member 327. A portion of cross-link member 37, being at a mid-point between the pivotal connections of third link 323 and fourth link 324, may itself have a pivotal connection 327P with a portion of lock bolt 330.

The axis for each of the two pivotal connections at the first and second ends of the second arm portion 321 may form a plane, which may generally be parallel to the plane formed by the axis at each of the pivotal connections of the second link 322, as seen in FIG. 30H. Similarly, the axis for each of the two pivotal connections at the first and second ends of the third link 323 may form a plane, which may generally be parallel to the plane formed by the axis at each of the pivotal connections of the fourth link 324. These planes formed by the axes at the pivotal connections of the arm portion 321, the second link 322, the third link 323, and the fourth link 324, may generally be orthogonal to an axis 330A of the lock bolt 330, when it is in the locked position seen in FIG. 30G.

Actuation of the first arm portion 320F of the actuating lever 320 using this arrangement, as seen in FIGS. 30H and 30I, may cause the lock bolt 330 to translate, to accommodate disengagement of its end 330E from the recesses, 310X and 310C, of the lock cylinder 310. The lock bolt 330 may be spring biased into contact with the lock cylinder, so that removal of the actuating force from the actuating lever 320 may automatically cause engagement of the end 330E of the lock bolt 330 within either of the recesses in the lock cylinder 310, when properly aligned therewith. The end of the lock bolt 330 may also have trapezoidal shape, and the recesses 310X and 310C may also have a corresponding trapezoidal shape that is configured to provide a small amount of clearance with the engagement end 330E of the lock bolt 330. This trapezoidal shape permits the engagement end 330E of the lock bolt 330 to initially engage either of the recesses (310X and 310C), even when they may be slightly misaligned with respect to the lock bolt (e.g., when the roller and associated links have not been fully rotated), because the width of the tip of the engagement end 330E of the lock bolt 330 is smaller than the peripheral portion of the recess of the lock cylinder that would initially be contacted. Such contact therebetween may also serve to drive the final portion of rotation of the lock cylinder to be in its proper position for the roller to be either fully collapsed or fully extended.

It may be seen by a comparison of FIGS. 30H and 30I that the throw required for engagement/disengagement of the engagement end 330E of the lock bolt 330 with/from the recesses (310X and 310C) of the lock barrel 310 may be set to be relatively small, which therefore only requires the lock bolt to generally travel in a straight line for a short amount of travel. Each of the above described pairs of links (321/322 and 323/324) and the corresponding cross-link members (325 and 327) supporting it resembles a Watts linkage (or parallel linkage), and in combination forms a dual Watts linkage arrangement. With a Watts linkage, the center points of the cross-link members (325 and 327) are each constrained to move in an approximation of a straight line, for a small amount of travel. With the lock bolt 330 moving from the engaged position in FIG. 30H to the disengaged position in FIG. 30I, the links 321/322 and the links 323/324 will no longer be parallel with each other, because they will each be pivoting about their respective hinge points, and will cause rotation of the cross-link members 325 and 327 with relatively little or no displacement of the respective hinge points of those cross-link members, hence, the lock bolt will generally be driven to translate along its axis 330A for the amount of throw needed for disengagement and re-engagement.

To provide greater stability for the movement of the lock bolt 330, symmetry of its actuation by the dual watts linkages formed by supporting/driving links 321/322 and 323/324, and the corresponding cross-link members 325 and 327, may be achieved by using a mirrored copy of those links on the opposite side of the lock bolt (e.g., additionally using supporting/driving links 321A/322A and 323A/324A, and cross-link members 325A and 327A), as seen in FIG. 30G.

An alternate embodiment of the roller frame 10 may also be constructed by replacing the “Z” shaped second link 60 with another, more simpler part that may also serve the same primary function. Although the second link 60 may secondarily serve in providing additional stability between the handle halves 80/90 and the coupler 20, above what is provided only by the first link 50, it primarily serves to maintain the proper orientation of the coupler 20 and axle 30, the cage 170, and roller cover 40 thereon, with respect to the handle. Therefore, as seen in FIG. 5A, the second link 60 could be replaced by a simple tension member, including, but not limited to an elastic bungee, or a cable with a spring. The tension member could be sized and positioned so that when the roller frame is in the collapsed position of FIG. 5C, is may not exert a force between the handle and the coupler, but when the trigger is actuated to move the roller frame into the extended position of FIG. 5A, the tension member becomes elongated beyond its rest position and applies a tension force therebetween, causing the coupler to pivot. The pivotal travel of the first link relative to the coupler being caused by the elongated tension member may be limited by one or more stops contacting the first link 50, so that the full extent of the coupler's travel relative to the first link may be as shown in FIG. 5A.

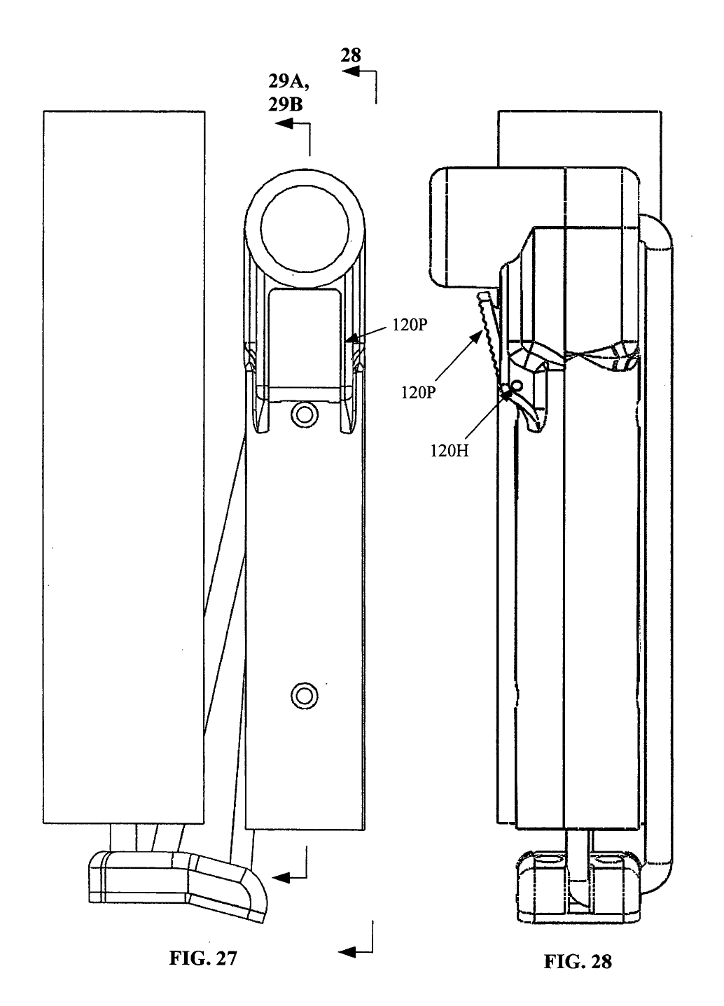

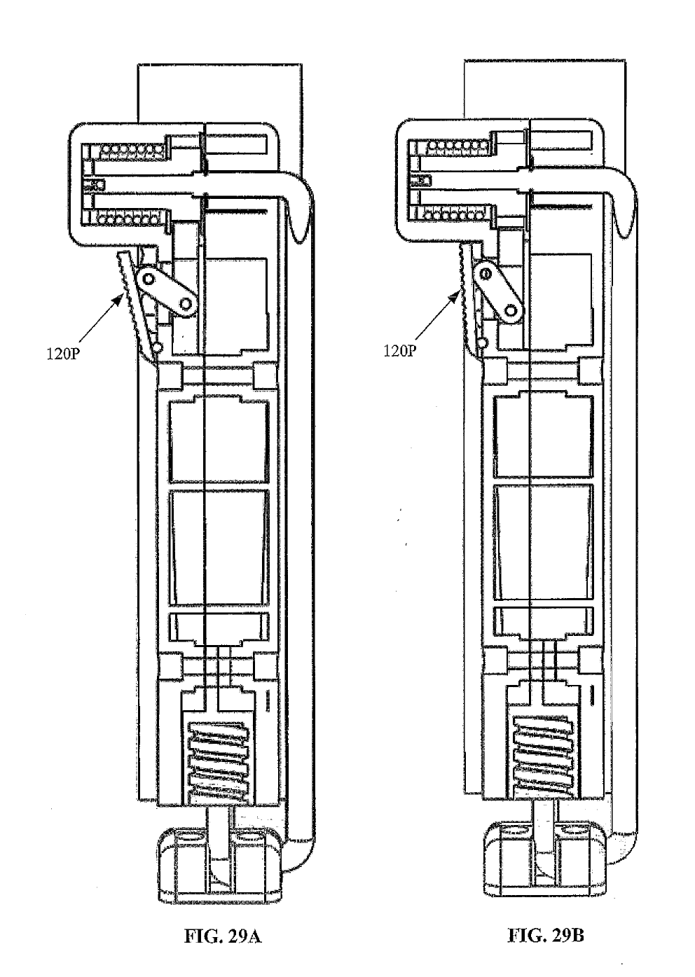

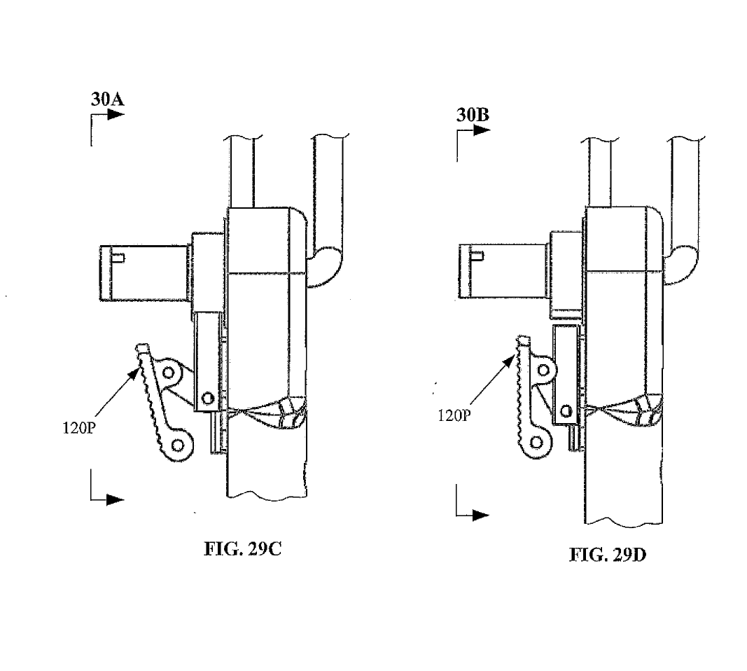

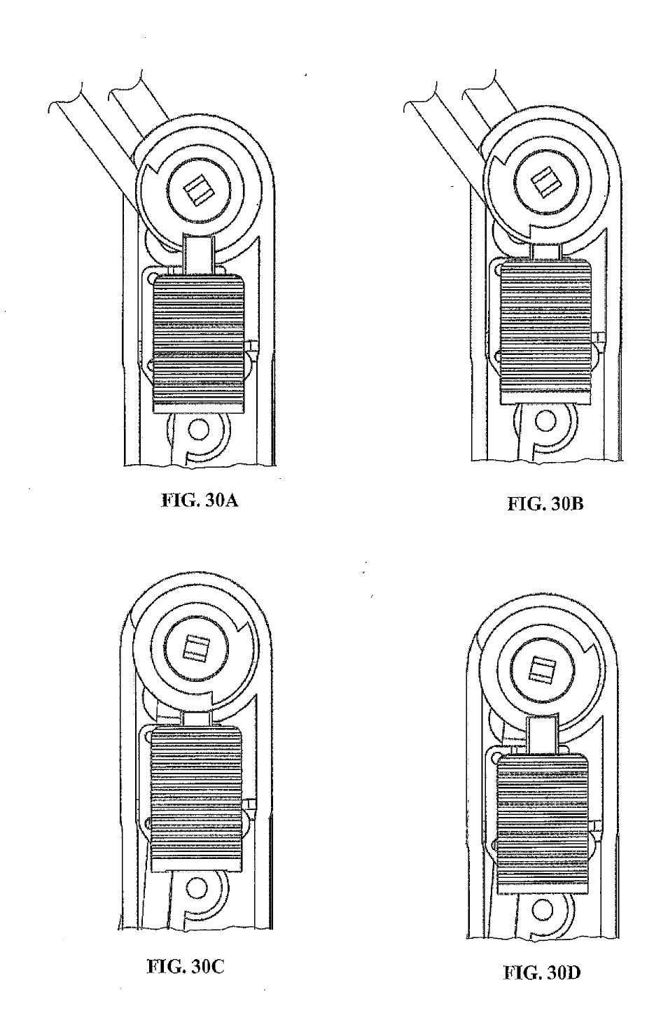

An alternate embodiment of the trigger release is shown within FIGS. 27, 28, 29A, and 29B, which show a pivotal trigger 120P that may pivot about a hinged attachment 120H with the handle, to drive the lock bolt from being engaged (FIG. 29C) to being disengaged (FIG. 29D).

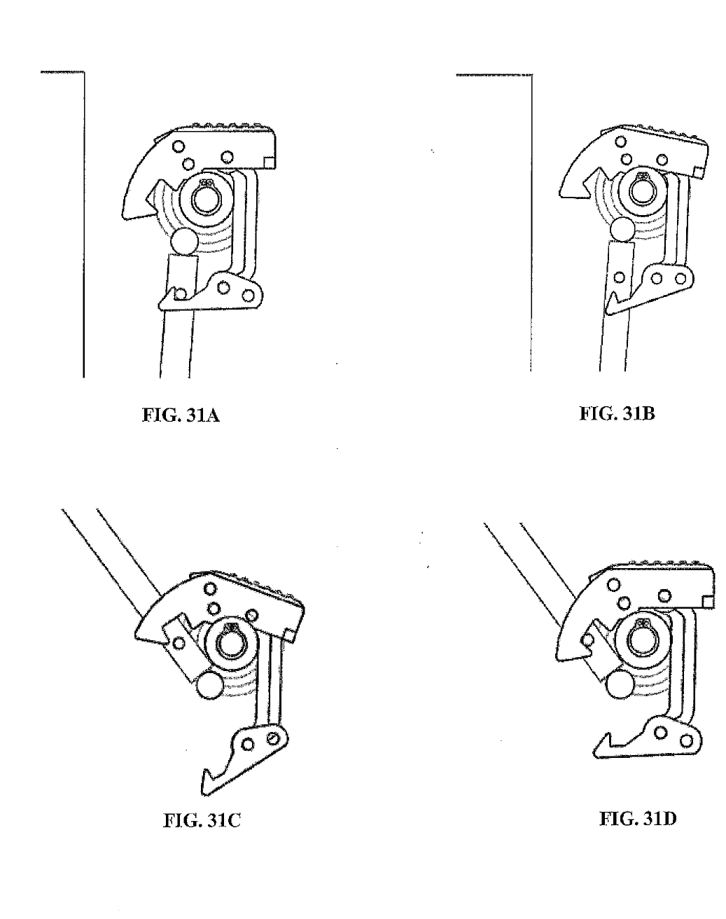

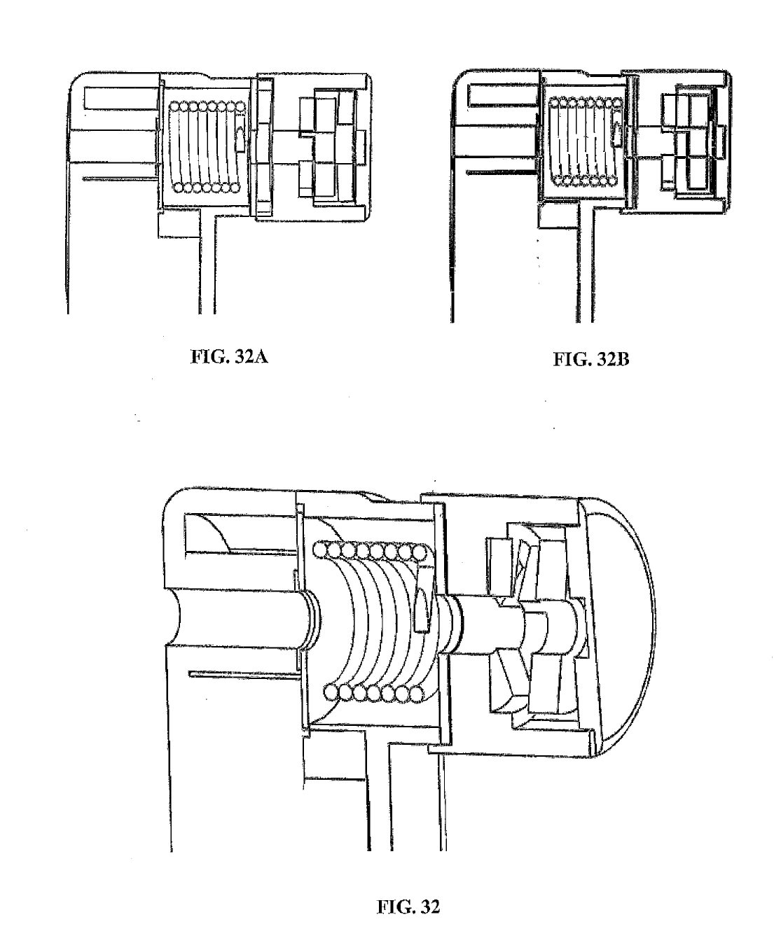

An alternate embodiment for controlling the motion of the collapsible roller frame of the present invention is shown by the jaw-lock mechanism within FIGS. 31A-31D, and by the clutch-brake lock mechanism of FIGS. 32, 32A, and 32B.

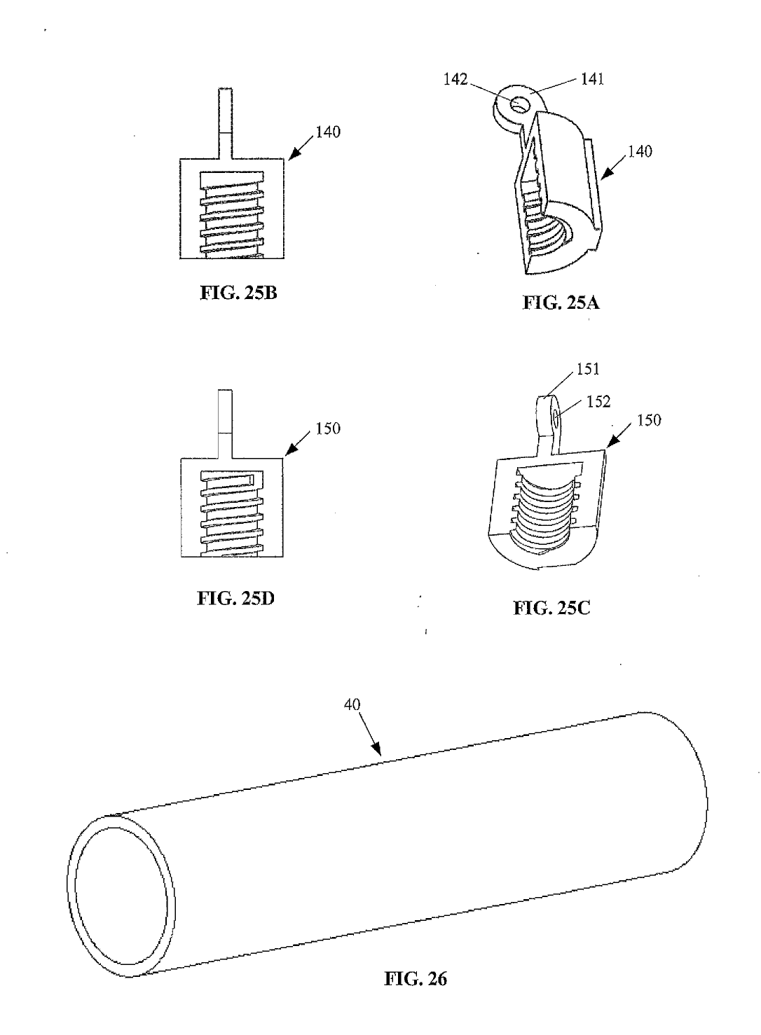

As seen in FIG. 4, any of the embodiments of the collapsible roller frame of the present invention may comprise threading in a bottom of the handle, which may be usable to receive a handle extension 205 to permit the user of the roller frame to reach distant areas on a high wall or ceiling that would otherwise be inaccessible without using a ladder. The present invention may utilize threaded insert halves 140 and 150, which are shown in detail in FIGS. 25A-25D. The insert halves 140 and 150 may be pushed together and inserted into the bottom opening of the handle halves 80 and 90. The insert halves may be retained therein by having the lowermost mechanical fastener 165L, which is otherwise only used for securing the handle halves together, also passing through an orifice 141/151 in a protrusion 142/152 of each insert half. A quick release fastener may be utilized so that the inserts may be quickly removed by the user, and be replaced by a different set of inserts, whereby the first set of inserts may comprise English threading for a handle extension having corresponding external English threading, and the second set of inserts may comprise metric threading.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

What is claimed is:

1. A collapsible paint roller frame, for use in receiving a roller cover that is capable of collecting and dispersing paint, said collapsible paint roller frame comprising:
an axle and a receiving means configured to slidably receive a roller cover thereon and configured to rotate relative to said axle;
a first link, said first link having a first end and a second end;
a second link, said second link having a first end and a second end;
a coupler, said coupler configured to fixedly receive an end of said axle therein; said coupler further configured to receive said first end of said first link in a pivotal relation therein, and to receive said first end of said second link in a pivotal relation therein;
a handle, said handle configured to receive said second end of said first link in a pivotal relation therein, and configured to receive said second end of said second link in a pivotal relation therein; and
wherein said handle is movable with respect to said axle using said first and second pivotable links, said handle being movable between a collapsed position and an extended position.

2. The collapsible paint roller frame according to claim 1 further comprising a torsion spring, a first end of said torsion spring configured to engage a portion of said handle, and a second end of said torsion spring configured to engage a portion of said second end of said first link, to thereby bias said handle relative to said axle.

3. The collapsible paint roller frame according to claim 2 wherein said torsion spring is configured to bias said handle to be in said collapsed position with respect to said axle, to thereby be proximate to said axle.

4. The collapsible paint roller frame according to claim 3 wherein said handle being proximate to said axle in said collapsed position comprises said handle being collapsed to thereby be generally parallel to said axle.

5. The collapsible paint roller frame according to claim 4 wherein said handle being proximate to said axle in said collapsed position comprises said handle being in contact with a roller sleeve received on said receiving means.

6. The collapsible paint roller frame according to claim 5 wherein said first link comprises a U-shaped link formed by a first leg and a second leg configured to extend from opposite ends of a base member, and to be parallel to each other and to extend in the same direction; and wherein said second link comprises a Z-shaped link formed by a first leg and a second leg configured to extend from opposite ends of a base member to be parallel to each other and to extend in opposite directions from said base member.

7. The collapsible paint roller frame according to claim 6 wherein said torsion spring comprises one or more helical windings that terminate with said first end being a tangential end secured to said portion of said handle, and that also terminate in said second end being a radial over-center end, with a portion of said radial over-center end being received within an orifice in said second leg of said U-shaped first link to thereby cause said bias.

8. The collapsible paint roller frame according to claim 7 further comprising a cylindrical lock barrel and a trigger, and comprising a flat portion on the end of said second leg of said U-shaped first link; said cylindrical lock barrel being received over said one or more windings of said torsion spring with the end of said second leg of said U-shaped first link being received through a keyway in an end wall of said cylindrical lock barrel to thereby interconnect said biased first link with said lock barrel; and wherein said trigger is movably mounted to said handle to be movable between a first position and a second position, said first position comprising a position where a portion of said trigger engages a corresponding opening in said lock barrel to thereby releasably inhibit movement of said lock barrel and said biased first link, and said second position comprising a position where said portion of said trigger is disengaged from said corresponding opening in said lock barrel to permit movement of said lock barrel and said biased first link.

9. The collapsible paint roller frame according to claim 8 wherein said handle comprises a first handle half and a second handle half configured to be secured to each other.

10. The collapsible paint roller frame according to claim 9 further comprising means for securing said first link and said second link in said pivotable relation within said coupler.

11. The collapsible paint roller frame according to claim 10 further comprising a threaded insert configured to receive a handle extension, said threaded insert being releasably received within an end of said handle.

12. The collapsible paint roller frame according to claim 11 wherein said trigger being movably mounted to said handle comprises said trigger being slidably mounted to said handle to be slidable between said first and second trigger positions.

13. The collapsible paint roller frame according to claim 11 wherein said trigger being movably mounted to said handle comprises said trigger being pivotally mounted to said handle to be pivotable between said first and second trigger positions.

14. The collapsible paint roller frame according to claim 7 further comprising:
a cylindrical lock barrel and a trigger, and comprising a flat portion on the end of said second leg of said U-shaped first link; said cylindrical lock barrel being received over said one or more windings of said torsion spring with the end of said second leg of said U-shaped first link being received through a keyway in an end wall of said cylindrical lock barrel to thereby interconnect said biased first link with said lock barrel; and
a first and second Watts linkage, and a lock bolt; each said first and second Watts linkages configured to cause said lock bolt to translate, by actuation of said trigger, and to selectively engage a first opening or a second opening in said lock barrel, to releasably inhibit movement of said lock barrel and said biased first link to at said collapsed handle position or said extended handle position, respectively.

15. A collapsible paint roller frame comprising:
an axle configured to receive a roller cage and cover to thereon be rotatable relative to said axle;
a first link, said first link having a first end and a second end;
a second link, said second link having a first end and a second end;
a coupler, said coupler configured to fixedly receive an end of said axle therein; said coupler further configured to receive said first end of said first link in a pivotal relation therein, and to receive said first end of said second link in a pivotal relation therein;
a handle, said handle configured to receive said second end of said first link in a pivotal relation therein, and configured to receive said second end of said second link in a pivotal relation therein; and
wherein said handle is movable with respect to said axle using said first and second pivotable links, said handle being movable between a first position and a second position.

16. The collapsible paint roller frame according to claim 15 further comprising a torsion spring, a first end of said torsion spring configured to engage a portion of said handle, and a second end of said torsion spring configured to engage a portion of said second end of said first link, to thereby bias said handle relative to said axle.

17. The collapsible paint roller frame according to claim 16 wherein said first link comprises a U-shaped link formed by a first leg and a second leg configured to extend from opposite ends of a base member, and to be parallel to each other and to extend in the same direction; and wherein said second link comprises a Z-shaped link formed by a first leg and a second leg configured to extend from opposite ends of a base member to be parallel to each other and to extend in the opposite direction from said base member.

18. The collapsible paint roller frame according to claim 17 wherein said torsion spring comprises one or more helical windings that terminate with said first end being a tangential end secured to said portion of said handle, and that also terminate in said second end being a radial over-center end, with a portion of said radial over-center end being received within an orifice in said second leg of said U-shaped first link to thereby cause said bias.

19. The collapsible paint roller frame according to claim 18 further comprising a cylindrical lock barrel and a trigger, and comprising a flat portion on an end of said second leg of said U-shaped first link; said cylindrical lock barrel being received over said one or more windings of said torsion spring with the end of said second leg of said U-shaped first link being received through a keyway in an end wall of said cylindrical lock barrel to thereby interconnect said biased first link with said lock barrel; and wherein said trigger is movably mounted to said handle to be movable between a first position and a second position, said first position comprising a position where a portion of said trigger engages a corresponding opening in said lock barrel to thereby releasably inhibit movement of said lock barrel and biased first link, and said second position comprising a position where said portion of said trigger is disengaged from said corresponding opening in said lock barrel to permit movement of said lock barrel and said biased first link.

20. The collapsible paint roller frame according to claim 19 further comprising means for securing said first link and said second link in said pivotable relation within said coupler.

21. The collapsible paint roller frame according to claim 20 wherein said handle comprises a first handle half and a second handle half configured to be secured to each other; and said collapsible paint roller frame further comprising a threaded insert configured to receive a handle extension, said threaded insert being releasably received within an end of said handle.
